(19) United States
(12) Patent Application Publication
(10) Pub. No.: US 2008/0070570 A1
(43) Pub. Date: Mar. 20, 2008

(54) Method and system for providing prepaid roaming support at a visited network that otherwise does not allow it

(76) Inventor: John Yue Jun Jiang, Danville, CA (US)

Correspondence Address: ARENT FOX LLP, 1050 CONNECTICUT AVENUE, N.W., SUITE 400, WASHINGTON, DC, 20036, US

(21) Appl. No.: 11/882,088

(22) Filed: Jul. 30, 2007

Related U.S. Application Data
(60) Provisional application No. 60/833,779, filed on Jul. 28, 2006.

(51) Int. Cl. H04Q 7/20

(52) U.S. Cl. 455/433

(57) ABSTRACT

The present invention provides a method for providing wireless services to a prepaid subscriber of an HPMN in a VPMN when the prepaid subscriber attempts to register at the VPMN. The method includes detecting at a first Signal Gateway (SG) of one or more SGs, a registration attempt by the prepaid subscriber at the VPMN. The method further includes causing by the first SG, an HLR associated with the HPMN to send a trigger profile information in a registration acknowledgement message to the first SG in response to a modified registration message, sent by the first SG, so as to imitate the VPMN's roaming support for WIN phase 2 and the prepaid subscriber's registration attempt at the HPMN having a WIN phase 2 support. Finally, the method includes sending a modified registration acknowledgement message by the first SG, to a VMSC/VLR associated with the VPMN to facilitate the prepaid subscriber's mobile communication in the VPMN.

### RELATED APPLICATIONS

This application claims priority from U.S. Provisional Patent Application Ser. No. 60/833,779 entitled “A prepaid CDMA roaming solution between an operator of WIN Phase 2 and an operator of WIN phase 1 or non-WIN support” filed on Jul. 28, 2006. The aforementioned provisional patent application is incorporated herein by this reference in its entirety.

### FIELD OF THE INVENTION

The present invention generally relates to mobile communication of roamers. More specifically, the invention relates to facilitating mobile communication for prepaid subscribers of a home network while they are roaming in a visited network that is unable to provide prepaid roaming services similar to the service offerings in their home network.

### BACKGROUND OF THE INVENTION

Mobile communication services to roaming subscribers are becoming increasingly popular with increasing number of roamers. Network operators across the world tend to earn maximum revenues from these roamers. Roaming subscribers who visit different countries or states add to the majority of this roaming revenue. Hence, many of these network operators offer international or national roaming to inbound roamers visiting their coverage area. Additionally, these network operators tend to offer the latest technologies and Value Added Services (VAS), such as General Packet Radio System (GPRS), etc to national or international roamers enticing them to remain connected to their network, thereby increasing the operators' overall revenue.

Usually, the network operators have preferred bilateral roaming agreements (“partnerships”) with each other that include more favorable roaming charges than that of non-partnership operators. Therefore, “preferred” visited networks are those that the home network prefers its outbound roamers (or subscribers) to register with, when traveling outside their home coverage area. Non-partner networks are “non-preferred” networks. Hence, the network operators can maximize their margins and even the roamers can get more attractive roaming rates and better services if the outbound roamers roam on their home operator's preferred (or partner) networks. However, these outbound roamers may manually select any of the network operators available in their roaming territory based on maximum benefits like latest technology offerings and favorable roaming charges. For example, if the outbound roamer's home network offers them prepaid services like VAS based on Wireless Intelligent Network (WIN) phase 2 then ideally these outbound roamers would like to continue using similar WIN phase 2 services while roaming in coverage of a visited network operator. Even the home network operator may like their outbound roaming subscribers to roam in a ‘preferred’ visited network that support such services similar to the offerings of the home network operator. Similarly, even a Mobile Virtual Network Operator (MVNO) of the home network operator that is offering wireless services to the subscribers of home network operator would prefer its subscribers to register at the preferred visited network that supports WIN phase 2 roaming services.

In Global System for Mobile communications (GSM), the partner visited network operator may provide prepaid roaming to outbound roamers of the home network that has a Customized Application for Mobile Enhanced Logic (CAMEL) support via an Unstructured Supplementary Service Data (USSD) call back service, in case the partner visited network operator does not possess roaming support for CAMEL. In case the partner visited network operator supports CAMEL roaming with the home network operator, then the prepaid roaming is facilitated via CAMEL protocol without the need of USSD call back service. However, there may also be a case where the home network operator has restricted roaming with CAMEL capabilities in the partner visited network irrespective of CAMEL support by the partner visited network.

Likewise, in Code Division Multiple Access (CDMA), despite the equivalent of USSD being a feature code trigger, rarely does any of the CDMA network operators implement prepaid roaming via this feature code trigger generated call back. Instead, they use CDMA WIN phase 2 protocol (an equivalent of GSM CAMEL protocol) to implement CDMA prepaid roaming for their outbound roamers. Some operators such as Verizon and China Unicom have implemented WIN phase 2 protocol that support their prepaid subscribers' roaming between these two networks. Postpaid subscribers of Verizon may roam in CDMA networks in different countries or regions, such as, but not limited to, Dominican Republic, Israel, Mexico, Puerto Rico, South Korea, and Venezuela. However, many of the network operators in these countries or regions do not support WIN phase 2 protocol with the home network operator. Hence, this poses a problem for prepaid subscribers of the home network operator, as these subscribers are unable to avail WIN phase 2 services while roaming in the partner visited network. Even some MVNO operators of Verizon such as Digicel USA may also like its prepaid subscribers to outbound roam in Latin American countries like Mexico.

However, one or more of existing solutions did not consider the scenario where a partner visited network operator could offer WIN phase 2 roaming services (or CAMEL services) to the prepaid subscribers of the home network that supports WIN phase 2 (or CAMEL) even when the home network operator restricts its prepaid subscribers to outbound roam with WIN phase 2 (or CAMEL) capabilities in the partner visited network. Moreover, in order to provide such WIN phase 2 (or CAMEL) services, these network operators need to upgrade various network elements like Home Location Register (HLR) and Mobile Switching Center (MSC) in their network infrastructure, which increases the overall cost.

In accordance with the foregoing, there is a need in the art of a system, a method, and a computer product, which allow prepaid subscribers of a home network with WIN phase 2 (or CAMEL) capabilities to outbound roam with similar WIN phase 2 (or CAMEL) support in a partner visited network even when the home network operator restricts roaming with WIN phase 2 (or CAMEL) capabilities in the partner visited network. This enables these prepaid subscribers to avail services specific to WIN phase 2 (or CAMEL) protocol, in addition to standard call and non-call related services, while roaming in the partner visited network.

### SUMMARY

The present invention is directed towards a system for providing wireless services to a prepaid subscriber, associated with an HPMN, in a VPMN when the prepaid subscriber attempts to register at the VPMN. The system includes a first Signal Gateway (SG) of one or more SGs for detecting a registration attempt by the prepaid subscriber at the VPMN. The first SG is coupled to one of the VPMN, the HPMN, and an MVNO of the HPMN. The first SG further causes an HLR associated with the HPMN to send a trigger profile information in a registration acknowledgement message to the first SG in response to a modified registration message that is sent by the first SG, so as to imitate the VPMN's roaming support for WIN phase 2 and the prepaid subscriber's registration attempt at the HPMN having a WIN phase 2 support. Finally, the first SG sends a modified registration acknowledgement message to a VMSC/VLR associated with the VPMN to facilitate the prepaid subscriber's mobile communication in the VPMN.

Another aspect of the invention presents a method for providing wireless services to a prepaid subscriber, associated with an HPMN, in a VPMN when the prepaid subscriber attempts to register at the VPMN. The method includes detecting at a first SG of one or more SGs, a registration attempt by the prepaid subscriber at the VPMN. The method further includes causing by the first SG, an HLR associated with the HPMN to send a trigger profile information in a registration acknowledgement message to the first SG in response to a modified registration message being sent by the first SG, so as to imitate the VPMN's roaming support for WIN phase 2 and the prepaid subscriber's registration attempt at the HPMN having a WIN phase 2 support. Finally, the method includes sending a modified registration acknowledgement message by the first SG, to a VMSC/VLR associated with the VPMN to facilitate the prepaid subscriber's mobile communication in the VPMN.

Yet another aspect of the present invention provides a computer program product including a computer usable program code for providing wireless services to a prepaid subscriber of an HPMN in a VPMN by detecting at a first SG of one or more SGs, a registration attempt by the prepaid subscriber at the VPMN. Thereafter, causing by the first SG, an HLR associated with the HPMN to send a trigger profile information in a registration acknowledgement message to the first SG in response to a modified registration message being sent by the first SG, so as to imitate the VPMN's roaming support for WIN phase 2 and the prepaid subscriber's registration attempt at the HPMN having a WIN phase 2 support. Finally, sending a modified registration acknowledgement message by the first SG, to a VMSC/VLR associated with the VPMN to facilitate the prepaid subscriber's mobile communication in the VPMN.

### BRIEF DESCRIPTION OF DRAWINGS

In the drawings, the same or similar reference numbers identify similar elements or acts.

FIG. 1 represents a first system for providing a first CDMA roaming solution to prepaid subscribers of a WIN phase 2 capable HPMN even when the HPMN operator restricts its prepaid subscribers to roam with WIN phase 2 capabilities in a partner VPMN, in accordance with an embodiment of the present invention;

FIG. 2 is a flowchart for implementing the first CDMA roaming solution in either the partner VPMN or the HPMN or a Mobile Virtual Network Operator (MVNO) of the HPMN, in accordance with an embodiment of the present invention;

FIG. 3 represents a second system for providing a second CDMA roaming solution to prepaid subscribers of the HPMN when the HPMN operator restricts its prepaid subscribers to roam with WIN phase 2 capabilities in the partner VPMN, in accordance with an embodiment of the present invention;

FIG. 4 is a flowchart for implementing the second CDMA roaming solution in both the partner VPMN and the HPMN (or the MVNO of the HPMN instead of the HPMN), in accordance with an embodiment of the present invention;

FIG. 5 represents a flow diagram of a registration process of the prepaid subscriber in the partner VPMN, in accordance with an embodiment of the present invention;

FIGS. 6A, 6B, 6C, and 6D represent a flow diagram of Mobile Originated (MO) call from the prepaid subscriber's handset while roaming in the partner VPMN, in accordance with an embodiment of the present invention; and

FIGS. 7A, 7B, and 7C represent a flow diagram of Mobile Terminated (MT) call received on the prepaid subscriber's handset while roaming in the partner VPMN, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified, so as not to obscure the present invention. Furthermore, reference in the specification to “one embodiment” or “an embodiment” means that a particular feature, structure or characteristic, described in connection with the embodiment, is included in at least one embodiment of the invention. The appearance of the phrase “in an embodiment”, in various places in the specification, does not necessarily refer to the same embodiment.

The present invention provides a system, a method, and a computer program product that allows prepaid subscribers of a Wireless Intelligent Network (WIN) phase 2 capable home network to access various WIN phase 2 prepaid services in a partner visited network, even when the home network operator restricts roaming with WIN phase 2 capabilities in the partner visited network. The home network operator restricts roaming irrespective of whether the partner visited network has WIN phase 2 support, in accordance with various embodiments of the present invention. In some cases, the partner visited network may be restricted even if it has WIN phase 1 support or no WIN support, both of which are hereinafter interchangeably referred to as non-WIN phase 2 support. It will be apparent to a person skilled in the art that the wireless services include standard call and non-call related activities, such as, but not limited to, MO call, MT call, Short Message Service (SMS), Packet Data Network (PDN), and other Value Added Services (VAS) such as SMS forwarding and SMS filtering. Furthermore, WIN protocol allows network operators to add various capabilities to their existing network infrastructure. However, this requires these network operators to perform some software upgrades in their respective network components, or install additional network components such as, but not limited to, Service Control Points (SCPs), Service Nodes (SNs), or Intelligent Peripherals (IPs) to their existing network infrastructure. For example, an operator ‘X’ having WIN phase 1 capabilities may like to upgrade to WIN phase 2, for which it needs to upgrade or install some or all of the above mentioned components. Upgrading to WIN phase 2 allows the operator ‘X’ to add triggers and other capabilities to its network that supports various charging services such as Prepaid, Freephone, Premium Rate, and Advice of Charging (AoC). The system in accordance with various embodiments of the present invention, allows the visited network operators to provide WIN phase 2 prepaid services to the WIN phase 2 prepaid subscribers without performing any software upgrades and installing the above mentioned components to their existing infrastructure. The present system also ensures that the home network operator does not need to modify any roaming profile information, associated with its prepaid subscribers, in its Home Location Register (HLR). The present system also allows an MVNO of the home network operator to offer WIN phase 2 services to the prepaid subscribers of the home network in the partner visited network without affecting home network operator's network infrastructure.

Similarly, in case of Global System for Mobile communication (GSM), the present system allow prepaid subscribers of a Customized Applications for Mobile network Enhanced Logic (CAMEL) phase 3 capable home network roaming in a partner visited network to use various CAMEL capable prepaid services, even when the home network operator restricts roaming with CAMEL support in the partner visited network. In some cases, the partner visited network may be restricted even if it has CAMEL phase 1 (or phase 2) support or may not even have CAMEL support, all three of which are hereinafter interchangeably referred to as non-CAMEL support. A mapping table between GSM and CDMA standards correlating various MAP messages used in case of CAMEL/Intelligent Network (IN) and American National Standards Institute #41 (ANSI-41) based networks are described later in context of the present invention.

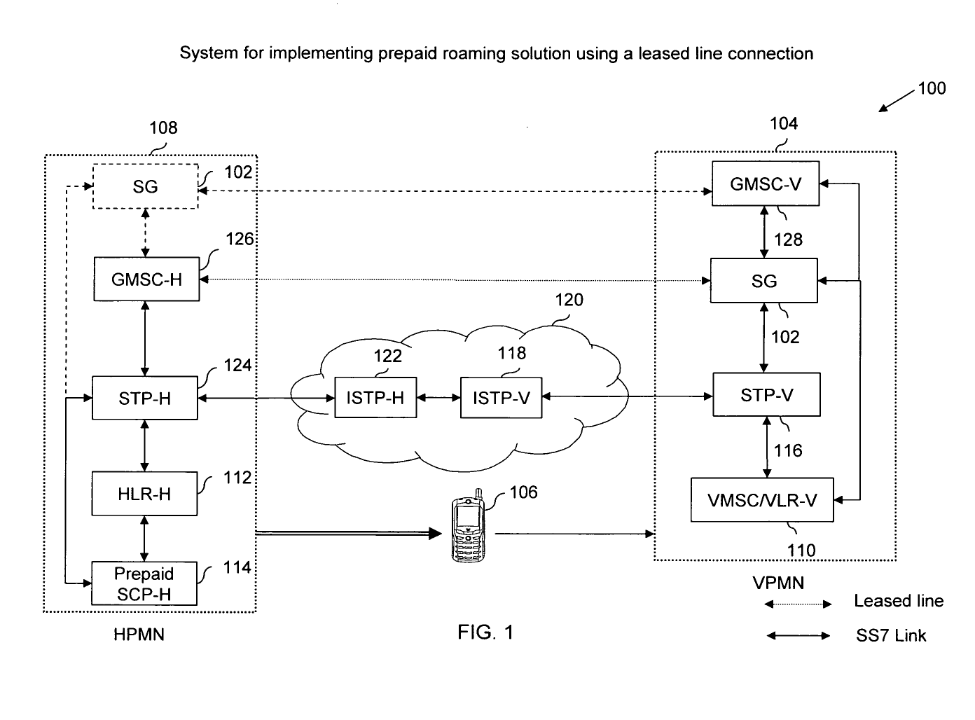

In order to provide WIN phase 2 prepaid services to these prepaid subscribers, the partner visited network operator needs to emulate/fake the prepaid subscriber's location and their support for WIN phase 2 support, while these prepaid subscribers are roaming in the partner visited network. This creates a false impression on the home network operator, thereby allowing the prepaid subscribers to register and avail WIN phase 2 prepaid services in the partner visited network. Therefore, the present invention provides two systems (or solutions) to allow prepaid subscribers to register at the partner visited network, and subsequently perform WIN phase 2 capable mobile activities in the partner visited network. FIG. 1 represents a first system 100 for providing a first CDMA roaming solution to the prepaid subscribers, in accordance with an embodiment of the present invention. System 100 includes a first Signal Gateway (SG) 102 coupled to a partner Visited Public Mobile Network (VPMN) 104 (i.e. the partner visited network) to allow a prepaid subscriber 106 of a Home Public Mobile Network (HPMN) 108 (i.e. the home network) to register at partner VPMN 104. Hence, an operator in partner VPMN 104 provides these WIN phase 2 prepaid services using first SG 102, which is hereinafter interchangeably referred to as SG 102. Hereinafter, for sake of convenient reference, prepaid subscriber 106 is interchangeably referred to as subscriber 106. Since the WIN phase 2 prepaid services are applicable only for partner VPMN 104, it is hereinafter interchangeably referred to as VPMN 104, in accordance with various embodiments of the present invention. In one embodiment of the present invention, SG 102 resides in HPMN 108 (represented in dashed line in FIG. 1). In another embodiment of the present invention, SG 102 may even reside in an MVNO's network (not shown in FIG. 1) associated with HPMN 108, which eliminates the need of any modification in HPMN 108's network infrastructure. It will be apparent to a person skilled in the art that the functionalities of SG 102 remain unchanged irrespective of its location.

System 100 further includes in VPMN 104, a Visitor Location Register (VLR) 110 that is integrated with a Visited Mobile Switching Center (VMSC) in VPMN 104. As VLR 110 and its integrated VMSC reside in VPMN 104, collectively they are interchangeably referred to as VMSC/VLR-V 110. However, both the VLR and the VMSC may have different logical addresses. Additionally, HPMN 108 includes a HLR 112 and a prepaid SCP 114. As HLR 112 and prepaid SCP 114 reside in HPMN 108, they are hereinafter referred to as HLR-H 112 and prepaid SCP-H 114, respectively. It will be apparent to a person skilled in the art that HLR-H 112 stores profile data corresponding to all subscribers of HPMN 108. Prepaid SCP-H 114 is used to control and perform various subscriber (or application specific service) logic in response to a query from a Service Switching Point (SSP), which is VMSC/VLR-V 110 (and SG 102 in some cases).

Subscriber 106's signaling in VPMN 104 is routed via a roaming Signaling Transfer Point (STP) 116 and an International STP (ISTP) 118 to HPMN 108. Since STP 116 and ISTP 118 reside in VPMN 104, they are hereinafter referred to as STP-V 116 and ISTP-V 118, respectively. Similarly, subscriber 106's signaling in HPMN 108 is routed to VPMN 104 using Signaling System #7 (SS7) signaling architecture 120 that involves an International STP-H 122 connected to a roaming STP-H 124 in HPMN 108. The signals exchanged between different networks are Transaction Capabilities Application Part (TCAP) including Mobile Application Part (MAP), Camel Application Part (CAP) and the like based signals. In another embodiment of the present invention, the signals exchanged are Signaling Connection Control Part (SCCP) based routing signals. It would be apparent to a person skilled in the art that any network element in HPMN 108 and VPMN 104 may communicate with each other via SS7 signaling architecture 120. It would also be apparent to a person skilled in the art that VPMN 104 and HPMN 108 may also include various other network components (not shown in FIG. 1), depending on the architecture under consideration.

It will be apparent to a person skilled in the art that SG 102 and a GMSC 126 (i.e. a gateway switching center) associated with HPMN 108 may communicate via an SS7 or an Internet Protocol (IP) link when SG 102 is coupled to VPMN 104. Since GMSC 126 is coupled to HPMN 108, it is hereinafter referred to as GMSC-H 126. However, this requires the operator in HPMN 108 and the operator in VPMN 104 to configure their respective STPs for exchange of subscriber 106's signaling, in order to allow gateways (i.e. SG 102 and GMSC-H 126) to interact with each other. These operators may also want a secured communication between these gateways to exchange subscriber 106's signaling. However, usually since SS7 and IP links are not completely secured, SG 102 and GMSC-H 126 need to communicate using their respective Global Titles (GTs), and have to depend upon STP-V 116 for routing of various signaling messages as per the routing defined for these GTs on incoming messages. Alternatively, the operator in HPMN 108 can arrange a leased line connection between SG 102 and GMSC-H 126. Since the leased line is a secured connection, the gateways can communicate with each other directly using a Signal Point Code (SPC) of the destination party without using GT Translation (GTT). In another embodiment of the present invention, when SG 102 is coupled to HPMN 108 (or MVNO of HPMN 108), the operator in HPMN 108 (or MVNO of HPMN 108) can arrange a leased line connection (represented in dashed line in FIG. 1) between SG 102 and a gateway switching center associated with VPMN 104. In an embodiment of the present invention, this gateway switching center is a GMSC 128 coupled to VPMN 104, which is hereinafter referred to as GMSC-V 128. In one embodiment of the present invention, if the operator in HPMN 108 already has a leased line connection with the operator in VPMN 104, it can use this connection for secured exchange of signaling messages between SG 102 and GMSC-H 126 (or GMSC-V 128 instead of GMSC-H 126). Essentially, the first prepaid CDMA solution represented in first system 100 provides WIN phase 2 prepaid services in VPMN 104 using the leased line connection, and hence this solution is hereinafter interchangeably referred to as ‘prepaid roaming using a leased line’ solution.

SG 102 interacts with various components in HPMN 108 via a WIN phase 2 protocol, as HPMN 108 supports WIN phase 2. However, while interacting with various components in VPMN 104, SG 102 uses an ISDN User Part (ISUP) protocol, as VPMN 104 may not support WIN phase 2. Since SG 102 communicates with HPMN 108 via WIN phase 2 protocol and with VPMN 104 via ISUP protocol, it can use TCAP transaction identifiers to correlate ANSI-41 (or IS-41) and GSM MAP/CAP operations. In an embodiment of the present invention, in case VPMN 104 supports WIN phase 2 capabilities, SG 102 uses WIN phase 2 protocol to interact with various components in VPMN 104.

In an embodiment of the present invention, SG 102 uses a GT and a SPC of VPMN 104 to communicate with various components in VPMN 104 that indicates presence of SG 102 in VPMN 104. In another embodiment of the present invention, SG 102 selects a GT and a SPC from a pool of GTs and SPCs that are allocated by the operator in VPMN 104 to do so. However, while interacting with various components in HPMN 108, SG 102 uses a GT and a SPC of HPMN 108 to imitate its presence in HPMN 108. By doing so, the operator in VPMN 104 is able to create a perception to the operator in HPMN 108 that subscriber 106 is in HPMN 108, even though subscriber 106 is actually in VPMN 104. Likewise, SG 102 either can use a GT and a SPC of HPMN 108, or may select a GT and a SPC from a pool of GTs and SPCs that are allocated by the operator in HPMN 108 to communicate with various components in HPMN 108. Now, in case, SG 102 uses the GT of VPMN 104 (or the GT of HPMN 108), it needs to maintain subscriber 106's location information, such as HLR-H 112 and VMSC/VLR-V 110, in addition to roaming profile information (i.e. WIN phase 2 profile) corresponding to subscriber 106. However, if SG 102 uses a pool of GTs and SPCs, it only needs to maintain roaming profile information corresponding to subscriber 106. In addition to faking subscriber 106's location (using the single GT or pool of GTs), SG 102 also emulates VPMN 104's roaming support for WIN phase 2 at HLR-H 112, in order to allow subscriber 106 to register at VPMN 104.

Since the operator in VPMN 104 installs SG 102 in its network, the operator in HPMN 108 does not require modifying its HLR-H 112 for subscriber 106. Furthermore, SG 102 applies various application logics when interacting with HPMN 108 and VPMN 104 to facilitate subscriber 106's mobile communication in VPMN 104. In one embodiment of the present invention, SG 102 adds a configurable prefix to a Mobile Directory Number (MDN) of subscriber 106 during an ongoing registration process of subscriber 106 in VPMN 104. This ensures that when a call on the prefixed MDN of subscriber 106 is received at VMSC/VLR-V 110, VMSC/VLR-V 110 based on the prefix determines that the call needs to be routed to SG 102. In an embodiment of the present invention, all calls initiated by the prepaid subscribers of HPMN 108, who have subscribed to the first CDMA roaming solution will be redirected to SG 102 based on the prefix to their MDNs. Therefore, when SG 102 receives a call request on the prefixed MDN from VMSC/VLR-V 110, SG 102 removes the prefix and performs other necessary functions (e.g. assists VMSC/VLR-V 110 in establishing call setup with called party GMSC) to facilitate subscriber 106's mobile communication in VPMN 104.

In order to allow subscriber 106 to initiate calls in VPMN 104, the operator in VPMN 104 configures its switch (i.e. VMSC/VLR-V 110) based on prefixes of calling number. In an embodiment of the present invention, VMSC/VLR-V 110 routes an ISUP call to SG 102 when prefix of a calling number is known to be configured by the operator in VPMN 104. Logistically, VMSC/VLR-V 110 creates either an ISUP voice trunk loopback or an ISUP signaling to SG 102 in order to route all signaling messages corresponding to subscriber 106. In case of ISUP voice trunk loopback interface to SG 102, loopback circuits in VMSC/VLR-V 110 are configured for the prefixes of calling numbers. These calling number prefixes are configurable by VPMN 104 operator. In this case, only an ISUP signaling is redirected via SG 102, whereas the voice trunks are created within VMSC/VLR-V 110 using loopback circuits. In an alternate case involving ISUP signaling interface to SG 102, VMSC/VLR-V 110 is configured for prefixes of calling numbers to redirect both the ISUP signaling and voice trunking via SG 102, and hence no loopback circuits are created in this case.

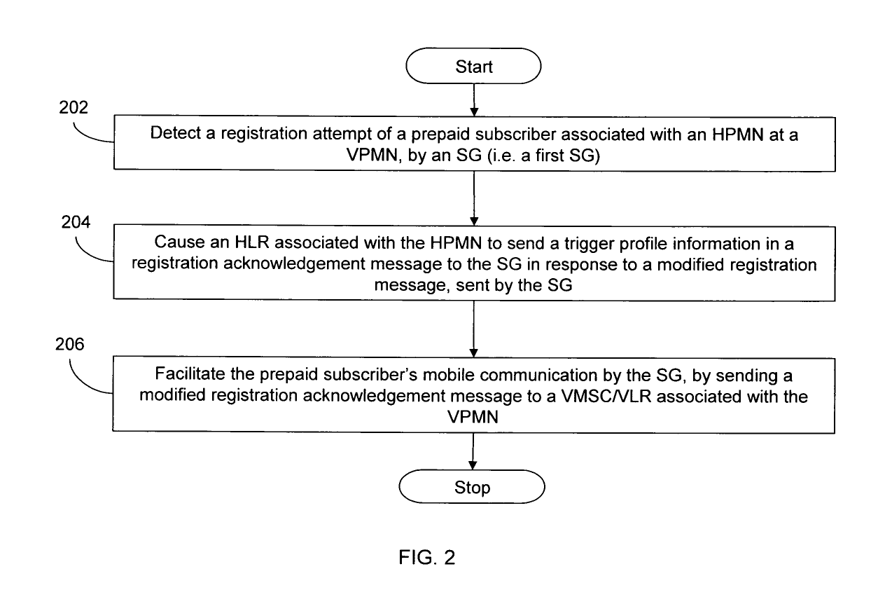

Interfacing VMSC/VLR-V 110 with SG 102 allows the operator in VPMN 104 to handle calls associated with subscriber 106 (i.e. based on prefix of the calling number, in case of MO calls), while subscriber 106 is roaming in VPMN 104. Moreover, the mobile activities performed by subscriber 106 in VPMN 104 are based on WIN phase 2, even though HLR-H 112 restricts roaming with WIN phase 2 capabilities in VPMN 104. In addition, these mobile activities are irrespective of whether VPMN 104 has roaming support for WIN phase 2. FIG. 2 is a flowchart for implementing the first CDMA roaming solution in either the partner VPMN or the HPMN or the MVNO of the HPMN, in accordance with an embodiment of the present invention. At step 202, an SG (i.e. a first SG) detects a registration attempt of a prepaid subscriber associated with an HPMN at a VPMN. In an embodiment of the present invention, SG 102 detects a registration attempt of subscriber 106 at VPMN 104, upon receiving a registration message such as MAP Registration Notification (REGNOT) from VMSC/VLR-V 110. REGNOT message is used to provide the location of subscriber's handset and optionally, to validate the subscriber's handset and obtain its profile information. In other words, REGNOT message provides the current location of subscriber at HLR-H 112, and is similar to a combination of MAP Location Update (LUP) and MAP Insert Subscriber Data (ISD) messages in GSM standard. SG 102 may then apply various application logics to emulate WIN phase 2 support and fake subscriber 106's location at HLR-H 112, in order to facilitate the registration process.

At step 204, the SG modifies the registration message and sends the modified registration message to an HLR associated with the HPMN, in order to cause the HLR to send a trigger profile information in a registration acknowledgement message to the SG. The modified registration message imitates the VPMN's roaming support for WIN phase 2 and the prepaid subscriber's registration attempt at the HPMN that already supports WIN phase 2. In an embodiment of the present invention, SG 102 modifies the REGNOT message by adding WIN Capability (WINCAP), and replacing Transaction Capability (TRANSCAP) with a modified TRANSCAP to imitate at HLR-H 112 that VPMN 104 has WIN phase 2 support. Additionally, SG 102 modifies VMSC/VLR-V 110 address in the REGNOT message with a GT of HPMN 108 to imitate at HLR-H 112 that subscriber 106 is attempting to register at HPMN 108 itself. This helps in overcoming the roaming restriction imposed by HPMN 108 for its prepaid subscribers roaming in VPMN 104. It will be apparent to a person skilled in the art that any component (i.e. apart from SG 102) in VPMN 104 can imitate WIN phase 2 capabilities of VPMN 104 and subscriber 106's location at any component (like prepaid SCP-H 114, apart from HLR-H 112) in HPMN 108. These modifications cause HLR-H 112 to send trigger profile information, such as TRIGADDRLIST in the registration acknowledgement message, such as ‘regnot’, to SG 102. It will be apparent to a person skilled in the art that TRIGADDRLIST provides a list of WIN triggers and destination SCP addresses to the requesting party (i.e. SG 102 in this case). Finally, at step 206 the SG facilitates the prepaid subscriber's mobile communication in the VPMN, by sending a modified registration acknowledgement message to a VMSC/VLR associated with the VPMN. In an embodiment of the present invention, SG 102 prefixes an MDN of subscriber 106 in the ‘regnot’ message, in order to distinguish this MDN with other MDN(s) received at VMSC/VLR-V 110. Thereafter, SG 102 sends this prefixed MDN in the ‘regnot’ message to VMSC/VLR-V 110 for further processing.

It will be apparent to a person skilled in the art that in order to avoid looping of routing of signaling messages, the operator in VPMN 104 can perform routing of signaling messages either using a Translation Types (or tables) (TT) or using an Message Transfer Part (MTP) routing technique. In case the TT technique is used, the operator in VPMN 104 configures STP-V 116 for both incoming and outgoing international SCCP signaling messages. For example, in case of an incoming message at STP-V 116 with TT as 0, Calling Party Address (CgPA) as HPMN 108 and Numbering Plan (NP) as E.212 address of a Mobile Identification Number (MIN), Destination Point Code (DPC) is set to SG 102 and the destination TT as 32. In case of an outgoing message from STP-V 116 with the TT as 32, Called Party Address (CdPA) as HPMN 108 and the NP as E.212, the DPC is set to ISTP-V 118 and the destination TT as 0. Routing Indicator (RI) and SCCP CdPA GT in all these cases will remain unchanged.

Considering the second technique of using MTP routing, the operator in VPMN 104 configures STP-V 116 to send an incoming message, with NP as E.212 and CgPA as HPMN 108, to the DPC as SG 102. SG 102 is configured for an international (i.e. HPMN 108) destined outgoing signaling message from SG 102 to STP-V 116, the DPC is set to ISTP-V 118, with RI and SCCP CdPA GT unchanged. In other words, in MTP routing technique involving outgoing messages, SG 102 using TT as 0 or unknown will have a GT translation that has DPC set to ISTP-V 118, with the SCCP message being sent to STP-V 116 first. Based on different incoming and outgoing messages from STP-V 116, SG 102 routes various MAP messages to allow subscriber 106 of WIN phase 2 capable HPMN 108 to register at VPMN 104, and subsequently facilitate mobile activities with WIN phase 2 support.

Further, in order to allow subscriber 106 to register with WIN phase 2 capabilities in VPMN 104, various other configurations are performed at SG 102. In an embodiment of the present invention, the operator in VPMN 104 configures STP-V 116 to redirect all SCCP signaling messages corresponding to subscriber 106, destined for HPMN 108, to SG 102. In other words, signaling messages with SCCP CdPA as HPMN 108 (i.e. E.212 address of MIN) are sent to SG 102 first. Thereafter, SG 102 modifies various MAP parameters in the received signaling message before routing the modified SCCP message to STP-V 116. In order to avoid looping of routing of signaling messages, the operator in VPMN 104 can route these messages using either TT or MTP routing techniques.

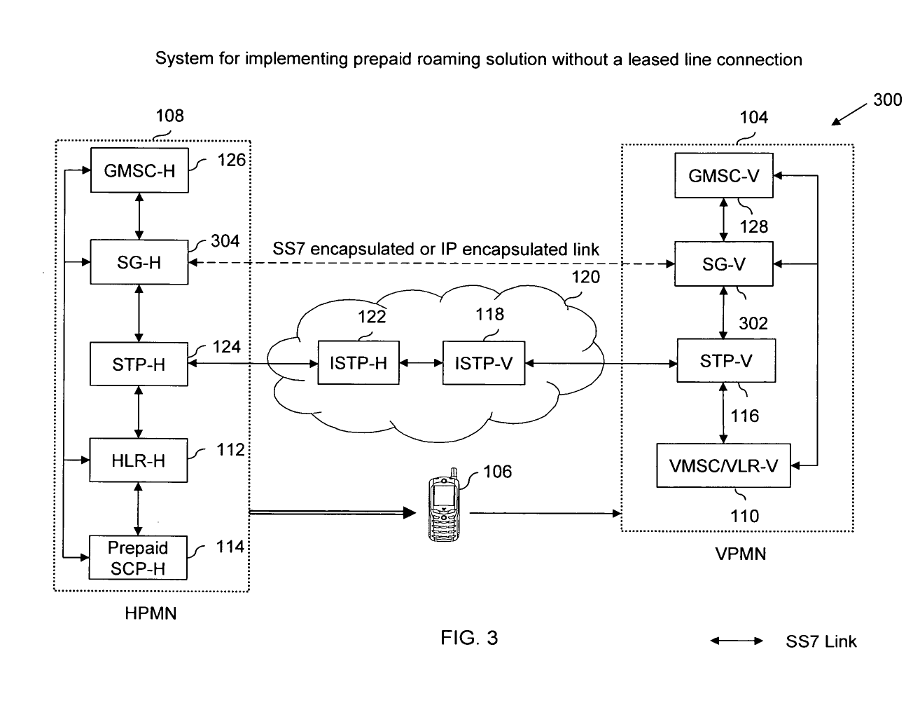

In the above mentioned first CDMA roaming solution, we have used a single SG (i.e. SG 102) and the leased line connection to provide roaming with WIN phase 2 capabilities in VPMN 104. In an alternative embodiment, there can be two SGs that can be deployed, one each at HPMN 108 and VPMN 104 or one each at MVNO of HPMN 108 and VPMN 104. This embodiment eliminates the need for a leased line connection between VPMN 104 and HPMN 108 (or MVNO of HPMN 108 instead of VPMN 104). FIG. 3 represents a second system 300 for providing a second CDMA roaming solution to the prepaid subscribers of HPMN 108, in accordance with an embodiment of the present invention. System 300 includes a first SG 302 coupled to VPMN 104 and a second SG 304 coupled to HPMN 108 (or the MVNO of HPMN 108), in order to provide WIN phase 2 prepaid services to subscriber 106 while he is roaming in VPMN 104. Hence, the operator in VPMN 104 is able to provide these services using first SG 302 and second SG 304, even though HPMN 108 restricts roaming with WIN phase 2 capabilities in VPMN 104. Likewise, the MVNO of HPMN 108 may offer these services using first SG 302 and second SG 304. Since first SG 302 resides in VPMN 104, it is hereinafter referred to as SG-V 302. Similarly, since second SG resides in HPMN 108 or MVNO of HPMN 108, it is hereinafter referred to as SG-H 304. All other network elements in system 300 are identical to the corresponding elements in system 100, except that SG 102 in system 100 is replaced by SG-V 302 and SG-H 304.

It will be apparent to a person skilled in the art that various functionalities of SG 102, described in the first CDMA roaming solution (i.e. ‘prepaid roaming using a leased line’) are similar to combined functionalities performed by SG-V 302 and SG-H 304. Hence, SG-H 304 interacts with various components in HPMN 108 using WIN phase 2 protocol, and SG-V 302 interacts with various components in VPMN 104 using ISUP protocol (or WIN phase 2 protocol in case VPMN 104 supports WIN phase 2). In addition, SG-H 304 relays various WIN 2 operations to SG-V 302 via an encapsulated SS7 link or IP link, in accordance with various embodiments of the present invention. In an alternate embodiment, SG-H 304 issues ISUP instructions to SG-V 302 via the encapsulated SS7 or IP link. It will be apparent to a person skilled in the art that the encapsulated link is a secured exchange of signaling messages between SG-V 302 and SG-H 304. This secured exchange can be performed via an SCCP/TCAP message exchange (i.e. SMS exchange), or by modifying an original SCCP CdPA (stored in a private extension of the TCAP content) with an intended SG party (i.e. SG-V 302 or SG-H 304) as the modified CdPA, depending upon the direction of the signaling messages. Since the secured SS7 encapsulated link is used, the second CDMA roaming solution in the second system 300 does not require any dedicated private connectivity (like leased line) between components in HPMN 108 and VPMN 104, unlike the first CDMA roaming solution. Hence, the second CDMA roaming solution is hereinafter interchangeably referred to as ‘prepaid roaming without a leased line’ solution. The exchange of signaling messages between SG-V 302 and SG-H 304 is illustrated using <ANSI-41 MAP Operation>’ notation to indicate the signaling message is encapsulated, irrespective of an encapsulation technique being used, in accordance with various embodiments of the present invention.

In an embodiment of the present invention, SG-V 302 communicates with various components in VPMN 104 using a GT and a SPC of VPMN 104 that indicates presence of SG-V 302 in VPMN 104. In another embodiment of the present invention, SG-H 304 interacts with various components in HPMN 108 using a GT and a SPC of HPMN 108 to create a perception to the operator in HPMN 108 that subscriber 106 is in HPMN 108, even though subscriber 106 is actually in VPMN 104. In an embodiment of the present invention, the operator in VPMN 104 and the operator in HPMN 108 allocate these GTs and SPCs to SG-V 302 and SG-H 304, respectively. In another embodiment of the present invention, SG-H 304 emulates VPMN 104's roaming support for WIN phase 2, in addition to faking subscriber 106's location at HLR-H 112, in order to allow subscriber 106 to register at VPMN 104. Further, SG-V 302 and SG-H 304 apply various application logics when interacting with VPMN 104 and HPMN 108, respectively, in order to facilitate subscriber 106's mobile communication in VPMN 104. In one embodiment of the present invention, SG-V 302 adds a configurable prefix to a MDN of subscriber 106 during an ongoing registration process of subscriber 106 at VPMN 104. In this embodiment, when subscriber 106 initiates a call using his MDN, SG-V 302 removes the prefix, and performs other necessary functions along with SG-H 304 (e.g. assists VMSC/VLR-V 110 in establishing call setup with called party GMSC), in order to facilitate subscriber 106's mobile communication in VPMN 104. The operator in VPMN 104 can configure its switch (i.e. VMSC/VLR-V 110) for prefixes of calling number, similar to the first CDMA roaming solution, except that SG-V 302, instead of SG 102 in the current solution will route ISUP call to VMSC/VLR-V 110.

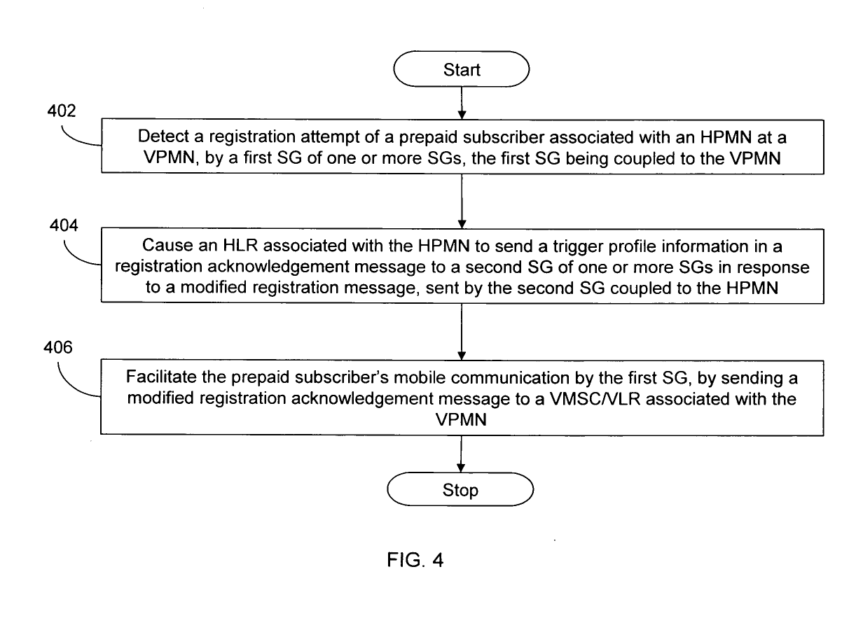

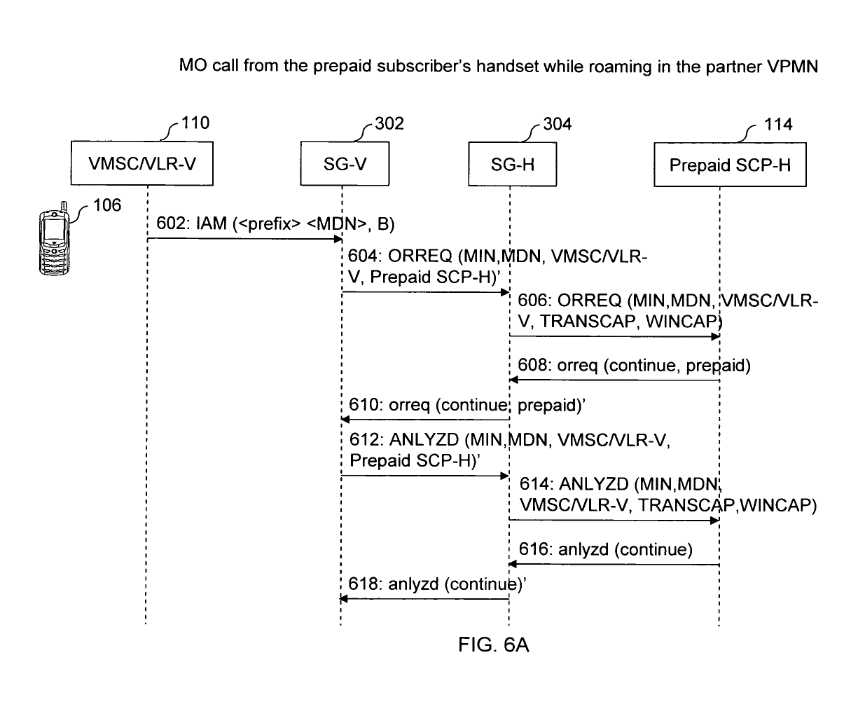

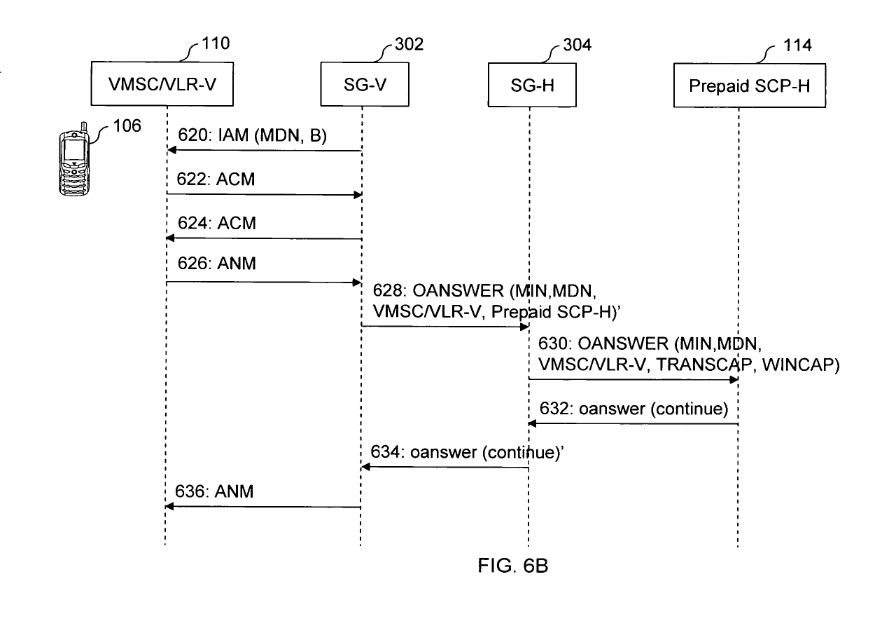

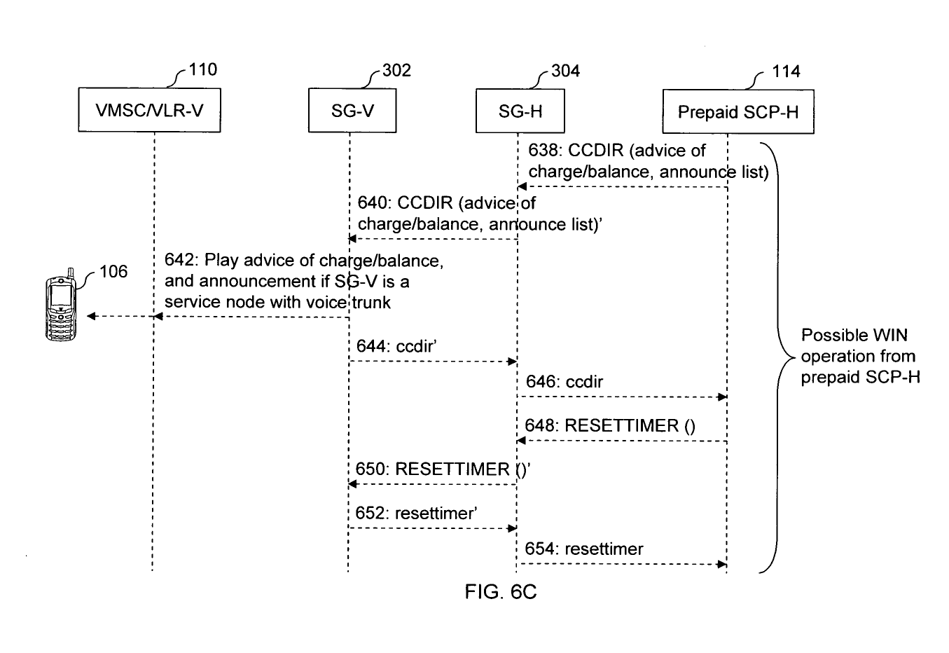

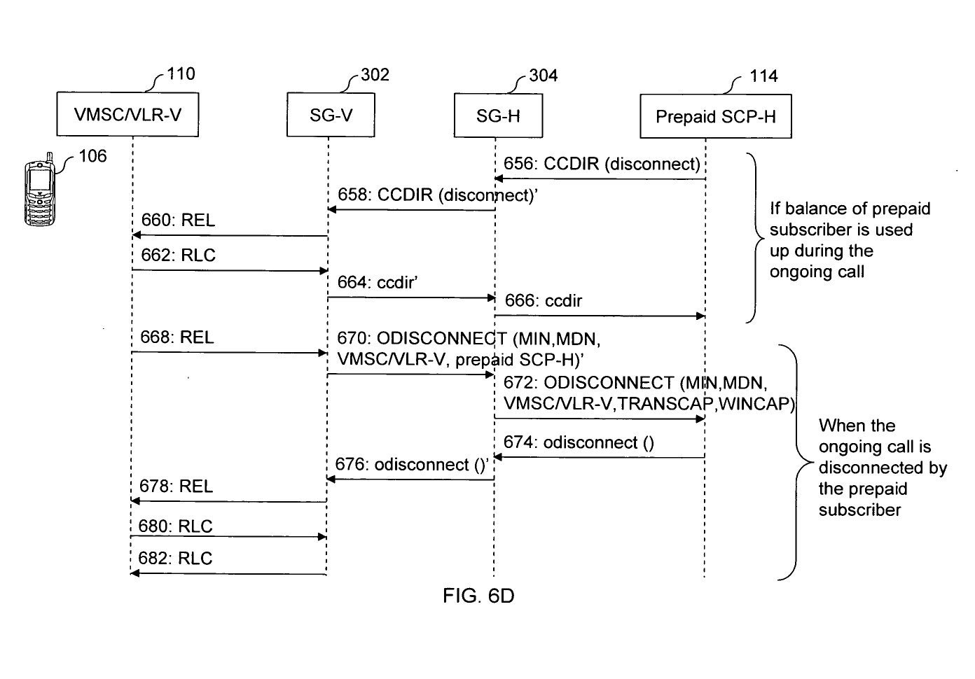

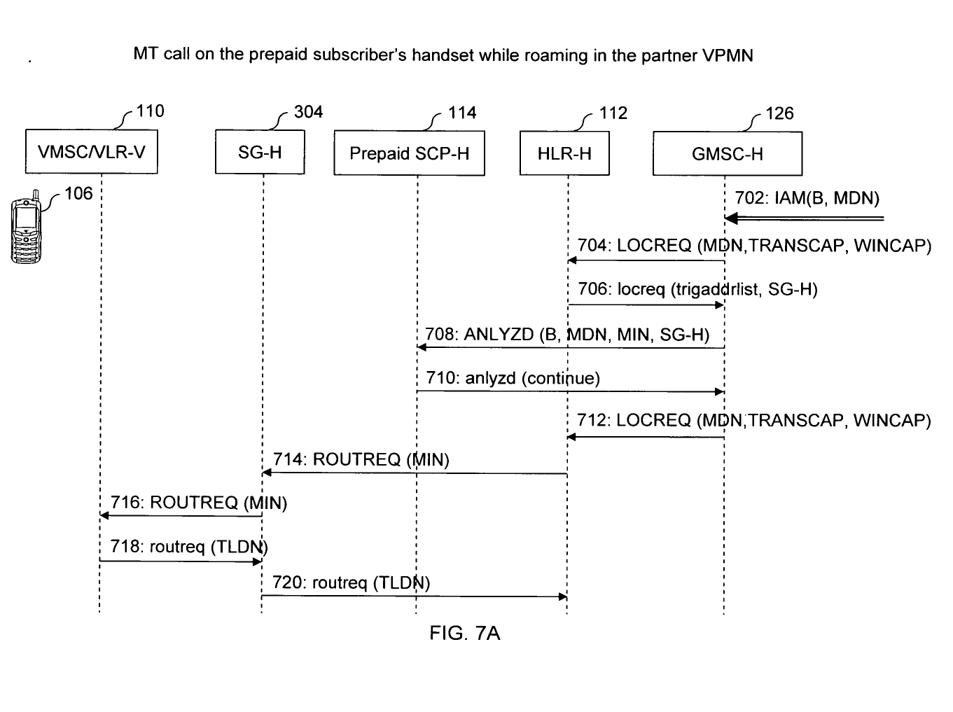

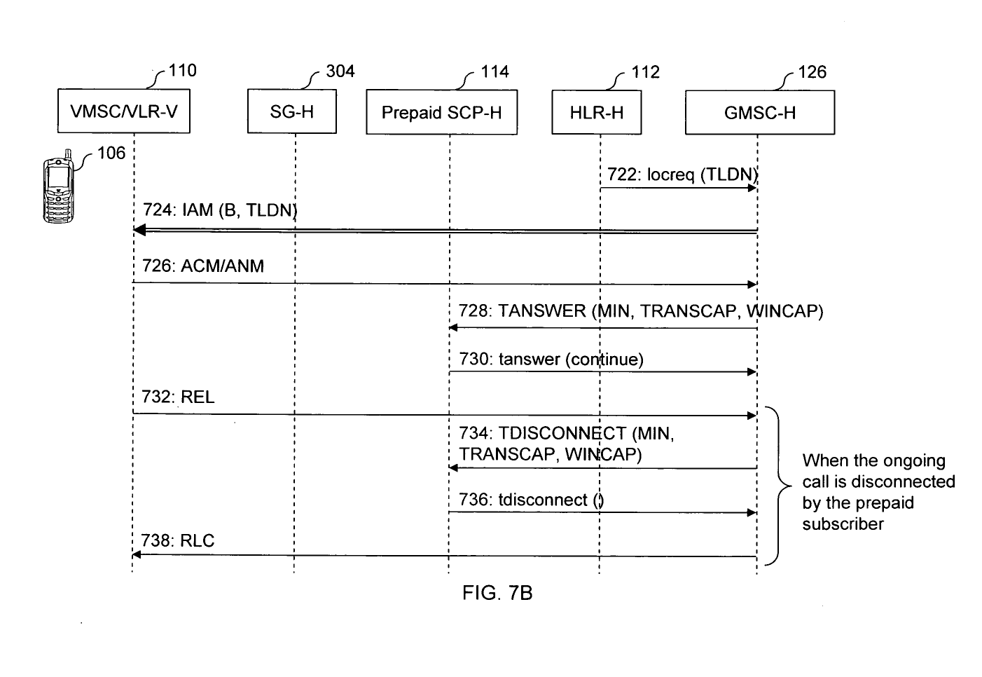

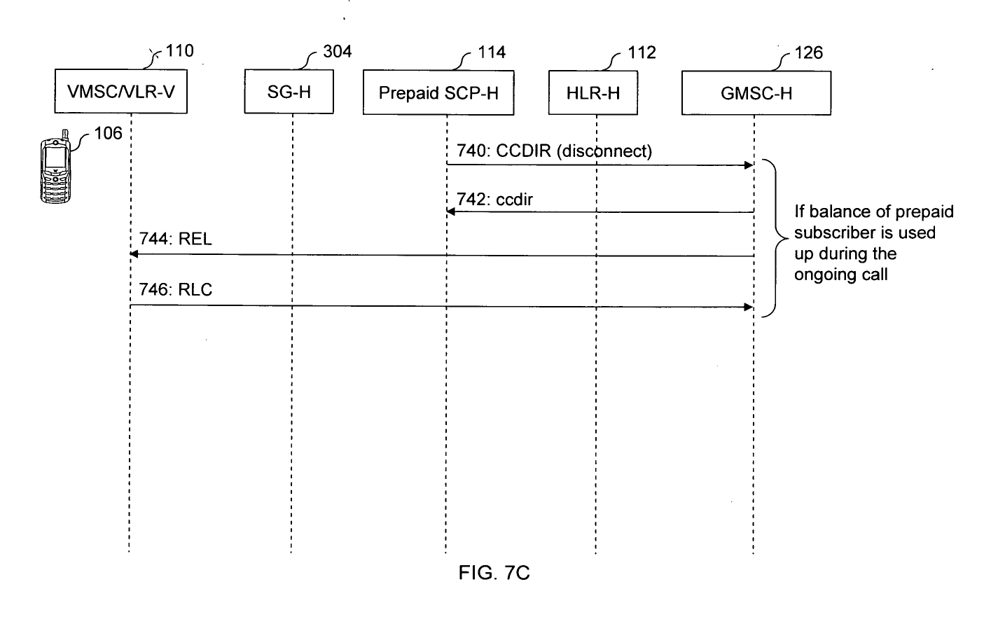

Interfacing VMSC/VLR-V 110 with SG-V 302 allows the operator in VPMN 104 to handle calls associated with subscriber 106 (i.e. based on prefix of the calling number, in case of MO calls), while subscriber 106 is roaming in VPMN 104. Moreover, the mobile activities performed by subscriber 106 in VPMN 104 are based on WIN phase 2, even though HLR-H 112 restricts roaming with WIN phase 2 capabilities in VPMN 104. In addition, these mobile activities are irrespective of whether VPMN 104 has roaming support for WIN phase 2. FIG. 4 is a flowchart for implementing the second CDMA roaming solution in both the partner VPMN and the HPMN (or the MVNO of the HPMN instead of the HPMN), in accordance with an embodiment of the present invention. At step 402, a first SG of one or more SGs detects a registration attempt of a prepaid subscriber associated with an HPMN at a VPMN, the first SG being coupled to the VPMN. In an embodiment of the present invention, SG-V 302 detects a registration attempt of subscriber 106 at VPMN 104, upon receiving a registration message such as MAP REGNOT from VMSC/VLR-V 110. Thereafter, at step 404, a second SG of one or more SGs, instead of the first SG, modifies the registration message and sends the modified registration message to an HLR associated with the HPMN, in order to cause the HLR to send a trigger profile information in a registration acknowledgement message to the second SG, coupled to the HPMN or the MVNO of the HPMN. The modified registration message imitates the VPMN's roaming support for WIN phase 2 and the prepaid subscriber's registration attempt at the HPMN. In an embodiment of the present invention, SG-H 304 modifies the REGNOT message by adding WINCAP and replacing TRANSCAP with a modified TRANSCAP to imitate at HLR-H 112 that VPMN 104 has WIN phase 2 support. Additionally, SG-H 304 modifies the VMSC/VLR address in the REGNOT message with a GT of HPMN 108 to imitate at HLR-H 112 that subscriber 106 is attempting to register at HPMN 108 itself. This helps in overcoming the roaming restriction imposed by HPMN 108 for its prepaid subscribers roaming in VPMN 104. These modifications cause HLR-H 112 to send trigger profile information, such as TRIGADDRLIST in the registration acknowledgement message, such as ‘regnot’, to SG-H 304. Thereafter, SG-H 304 relays the ‘regnot’ message to SG-V 302. Once the first SG receives the trigger profile information, the first SG finally facilitates the prepaid subscriber's mobile communication in the VPMN, by sending a modified registration acknowledgement message to a VMSC/VLR associated with the VPMN, at step 406. In an embodiment of the present invention, SG-V 302 prefixes an MDN of subscriber 106 in the ‘regnot’ message, in order to distinguish this MDN with other MDN(s) received at VMSC/VLR-V 110, and thereafter sends this prefixed MDN in the ‘regnot’ message to VMSC/VLR-V 110. Various embodiments for allowing subscriber to initiate and receive calls in the VPMN are described later in conjunction with FIGS. 6A, 6B, 6C, and 6D, and FIGS. 7A, 7B, and 7C, respectively.

The use of TT or MTP routing techniques are applicable in a similar way as explained for the first CDMA roaming solution. However, in the second CDMA roaming solution (i.e. ‘prepaid roaming without a leased line’), STP-V 116 will redirect the signaling messages to SG-V 302 (i.e. DPC will be SG-V 302), instead of SG 102. In addition, SG-H 304 instead of SG 102 is configured for an international (i.e. HPMN 108) destined outgoing signaling message towards STP-V 116, the DPC is still ISTP-V 118, with RI and SCCP CdPA GT still unchanged. The network operators can use any of the two above mentioned solutions to provide CDMA roaming solution to the prepaid subscribers of HPMN 108. However, in order to avail standard services (like initiate calls and SMS, and receive calls and SMS) in addition to WIN phase 2 specific services in VPMN 104, subscriber 106 first needs to register with VPMN 104.

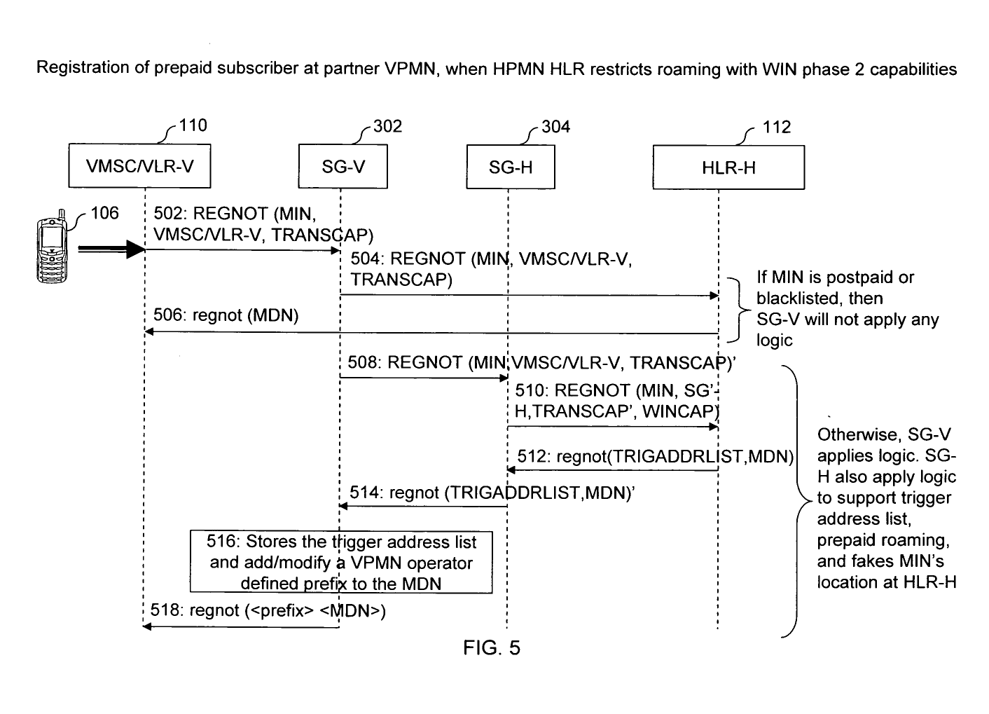

FIG. 5 represents a flow diagram of a registration process of prepaid subscriber 106 in partner VPMN 104, in accordance with an embodiment of the present invention. When subscriber 106 attempts to register at VPMN 104, VMSC/VLR-V 110 receives a registration message from a MIN of subscriber 106. At step 502, VMSC/VLR-V 110 sends the registration message such as REGNOT on the MIN of subscriber 106 to SG-V 302, with a VMSC/VLR-V 110 address, an Electronic Serial Number (ESN), and a TRANSCAP parameter indicating triggers supported by VMSC/VLR-V 110. In one embodiment of the present invention, SG-V 302 changes VMSC/VLR-V 110 address in the REGNOT message with the GT of VPMN 104 (i.e. SG-V GT or selects a GT from a pool of GTs). In another embodiment of the present invention, SG-V 302 does not modify any parameter in the received REGNOT message. It will be apparent to a person skilled in the art that VMSC/VLR-V 110 first sends the REGNOT message to STP-V 116, which then redirects the message to SG-V 302 as per the configuration done at STP-V 116. SG-V 302 then applies various application logics to determine if the MIN is postpaid or blacklisted.

In case MIN is determined to be postpaid or blacklisted, then at step 504, SG-V 302 bypasses (i.e. will not perform any further logic) the REGNOT message to HLR-H 112 (i.e. via STP-V 116). In an embodiment of the present invention, SG-V 302 determines the MIN either based on the MIN range (i.e. usually of 15 digits) or based on subscriber 106's profile information (i.e. retrieved from the REGNOT message, at step 502). Thereafter, at step 506, HLR-H 112 returns a registration acknowledgement message such as ‘regnot’ on an MDN of subscriber 106 directly to VMSC/VLR-V 110. It will be apparent to a person skilled in the art that in case the MIN is determined to be postpaid, the subscriber will register at VPMN 104 normally, without any intervention of SG-V 302 in any further process related to this postpaid subscriber. However, in case the MIN is determined to be blacklisted, SG-V 302 blocks the MIN, and hence the postpaid subscriber will not be able to register at VPMN 104.

Alternatively, SG-V 302 may determine the MIN as prepaid and not blacklisted, and in such a case will relay the received REGNOT message (i.e. at step 502) to SG-H 304 via the SS7 encapsulated link, at step 508. In one embodiment of the present invention, SG-H 304 stores subscriber 106's profile information (i.e. VMSC/VLR-V 110 address, ESN, MIN) received in the REGNOT message. SG-H 304 will then apply various application logics to imitate VPMN 104's roaming support for WIN phase 2 and fake subscriber 106's location at HLR-H 112. Hence, at step 510, SG-H 304 modifies the REGNOT message by replacing the TRANSCAP parameter (i.e. received at step 502) with a modified TRANSCAP parameter to update at HLR-H 112 that VPMN 104 has a WIN phase 2 trigger profile information support (i.e. TRIGADDRLIST support). SG-H 304 also adds a WINCAP parameter in the modified REGNOT message to update at HLR-H 112 that VPMN 104 has WIN phase 2 prepaid roaming support. The prepaid roaming support corresponds to WIN phase 2 trigger type support (like OANSWER and TANSWER) and WIN phase 2 prepaid operations (like CCDIR and RESETTIMER), in accordance with various embodiments of the present invention. Additionally, SG-H 304 also replaces VMSC/VLR-V 110 address with the GT of HPMN 108 (i.e. SG-H GT or selects a GT from a pool of GTs). This causes HLR-H 112, at step 512, to return roaming profile information such as an MDN of subscriber 106 and trigger profile information (i.e. TRIGADDRLIST) in a registration acknowledgement message such as ‘regnot’ to SG-H 304.

In one embodiment of the present invention, in case ISUP relay is used between SG-V 302 and SG-H 304, SG-H 304 stores the roaming profile information received in the ‘regnot’ message. SG-H 304 then relays the ‘regnot’ message to SG-V 302 via the encapsulated SS7 link, at step 514. In another embodiment of the present invention, in case WIN phase 2 relay is used between SG-V 302 and SG-H 304, SG-V 302 stores the roaming profile information received in the ‘regnot’ message, and SG-H 304 does not need to store the roaming profile information (i.e. at step 512). Thus, storing of the roaming profile information has a dependency on the relaying technique (i.e. ISUP or WIN phase 2) being used between SG-V 302 and SG-H 304. Hence, at step 516, SG-V 302 stores the TRIGADDRLIST and the MDN received in the ‘regnot’ message, and adds a prefix (which is configurable by the operator in VPMN 104) to this MDN. For example, the operator in VPMN 104 can add a prefix like ‘11’ or ‘#’ or ‘*67’ to the MDN. Finally, at step 518, SG-V 302 modifies a sender ID number and sets SCCP CgPA to SG-V 302, and subsequently sends the modified ‘regnot’ message (i.e. with prefixed MDN), without any roaming profile information to VMSC/VLR-V 110. It will be apparent to a person skilled in the art that the sender ID number corresponds to the GT of the sending party that is sending an SCCP message (e.g. REGNOT). In an embodiment of the present invention, VMSC/VLR-V 110 creates the ISUP voice trunk loopback with SG-V 302, in order to facilitate completion of the ongoing registration process in VPMN 104. The modification of sender ID number and CgPA ensures that further signaling corresponding to subscriber 106, received at VMSC/VLR-V 110, is subsequently redirected via SG-V 302. Moreover, by sending the prefixed MDN to VMSC/VLR-V 110, SG-V 302 ensures that the call request on this prefixed MDN is received at SG-V 302 from VMSC/VLR-V 110.

The registration process as described for the second CDMA roaming solution remains similar even for the first CDMA roaming solution (‘prepaid roaming using a leased line’). However, since their exists only one SG (i.e. SG 102) in the first CDMA roaming solution, it will be apparent to a person skilled in the art that SG 102 acts as the sole interface between HLR-H 112 and VMSC/VLR-V 110 for completing registration process in VPMN 104, which was earlier being handled by combination of SG-V 302 and SG-H 304.

Various other E.212 signaling messages (i.e. other than REGNOT) such as Qualification Request (QUALREQ), Qualification Directive (QUALDIR), Authentication Request (AUTHREQ), and AUTHDIR can be handled in a manner similar to the REGNOT message. It will be apparent to a person skilled in the art that QUALREQ is used to validate subscriber or to request subscriber's profile information, or both, whereas QUALDIR is used to update authorization information, profile information, or both. It will also be apparent to a person skilled in the art that AUTHREQ is used to request authentication of an authentication-capable subscriber, whereas AUTHDIR is used to request modification of subscriber's authentication parameters.

Once subscriber 106 is registered at VPMN 104, he can initiate calls in VPMN 104 that are WIN phase 2 compliant. However, this requires SG-V 302 (in case of the ‘prepaid roaming without a leased line’ solution) to apply application logics and perform desired functions based on the prefix of the calling number's MDN. FIGS. 6A, 6B, 6C, and 6D represent a flow diagram of MO call from prepaid subscriber 106's handset while roaming in partner VPMN 104, in accordance with an embodiment of the present invention. When subscriber 106 initiates a call using his MDN to a called party ‘B’, a call request first reaches VMSC/VLR-V 110. Thereafter, at step 602, as VMSC/VLR-V 110 determines the MDN as a prefixed MDN, it routes the call request using an Initial Address Message (IAM) (<prefix> <MDN>, B) via ISUP to SG-V 302. Thereafter, SG-V 302 removes the prefix from the prefixed MDN to obtain the original MDN. Using the original MDN, SG-V 302 determines its corresponding MIN and VMSC/VLR-V 110 address of subscriber 106. Additionally, SG-V 302 also determines prepaid SCP-H 114 from the TRIGADDRLIST (i.e. stored at SG-V 302 in FIG. 5). Thereafter, at step 604, SG-V 302 issues an Origination Request (ORREQ) operation on the MIN and the original MDN to SG-H 304, with CgPA as VMSC/VLR-V 110 address and CdPA as prepaid SCP-H 114. SG-H 304 determines the call from subscriber 106's MDN, and thus at step 606, SG-H 304 modifies the received ORREQ operation, by adding WINCAP parameter and modifying TRANSCAP parameter, and subsequently sends this modified ORREQ operation to prepaid SCP-H 114. ORREQ operation is used to request call origination treatment on behalf of a registered subscriber (i.e. subscriber 106 who is registered at VPMN 104). Furthermore, in various embodiments of the present invention, WINCAP operation will not support messages such as Connect Resource (CONNRES) and Disconnect Resource (DISCONNRES) when imitating WIN phase 2 WINCAP support at prepaid SCP-H 114. This is done to avoid any international voice connection to an Intelligent Peripheral (IP) associated with HPMN 108. CONNRES and DISCONNRES are used to request for establishing a connection and releasing an already established connection, respectively.

In an embodiment of the present invention, SG-H 304 does not modify the VMSC/VLR address in the ORREQ message (i.e. at step 606) based on an assumption that prepaid SCP-H 114 does not verify with HLR-H 112 on VMSC/VLR-V 110 address of subscriber 106. However, in case prepaid SCP-H 114 does verify with HLR-H 112 on VMSC/VLR-V 110 address, then SG-H 304 will replace this address in the ORREQ operation with the GT of HPMN 108. In order to deal with such a case, prepaid SCP-H 114 is defined with a tariff plan for subscriber 106 based on his current location, i.e., GT of HPMN 108, being emulated at prepaid SCP-H 114. It will be apparent to a person skilled in the art that SG-H 304 can be assigned a separate GT of HPMN 108 for each of its partner VPMNs.

Further, at step 608, prepaid SCP-H 114 returns an acknowledgement message, such as ‘orreq’ to SG-H 304, which at step 610 is relayed to SG-V 302 with a prepaid indication that instructs SG-V 302 to proceed with the call. In an embodiment of the present invention, the ‘orreq’ message provides routing information to SG-V 302 and is relayed via the encapsulated (SS7 or IP) link. Thereafter, at step 612, SG-V 302 sends an Analyzed Information (ANLYZD) operation on the MIN and MDN to SG-H 304, with CgPA as VMSC/VLR-V 110 address and CdPA as prepaid SCP-H 114. Thereafter, at step 614, SG-H 304 modifies the received ANLYZD operation, by adding WINCAP parameter and modifying TRANSCAP parameter, and subsequently sends this modified ANLYZD operation to prepaid SCP-H 114. ANLYZD operation is used to notify prepaid SCP-H 114 that trigger criteria at the Analyzed-information DP has been satisfied, and thereby prepaid SCP-H 114 can continue with the call processing. Thereafter, at step 616, prepaid SCP-H 114 returns an acknowledgement message such as ‘anlyzd’ to SG-H 304, which at step 618 is relayed to SG-V 302 that instructs SG-V 302 to continue with the ongoing call processing. Hence, at step 620, SG-V 302 issues ISUP IAM (MDN, B) to VMSC/VLR-V 110. Thereafter, at step 622, VMSC/VLR-V 110 sends Address Completion Message (ACM) to SG-V 302, which at step 624 returns an acknowledgement ACM message to VMSC/VLR-V 110, in order to confirm that voice trunks are reserved for the call setup. Further, at step 626, VMSC/VLR-V 110 issues Answer Message (ANM) to SG-V 302. This confirms that VMSC/VLR-V 110 has established the trunk for the ongoing call, and that the called party ‘B’ has answered the call. At step 628, SG-V 302 sends an OANSWER operation on the MIN and MDN to SG-H 304, with CgPA as VMSC/VLR-V 110 address and CdPA as prepaid SCP-H 114. It will be apparent to a person skilled in the art that O_Answer is an indication that the called party has answered the call. SG-H 304 then modifies the received OANSWER operation, by adding WINCAP parameter and modifying TRANSCAP parameter, and subsequently sending this modified OANSWER operation to prepaid SCP-H 114, at step 630. Thereafter, at step 632, prepaid SCP-H 114 returns an acknowledgement message such as ‘oanswer’ to SG-H 304, which at step 634 is relayed to SG-V 302. Thus, prepaid SCP-H 114 can begin the prepaid billing for subscriber 106's MDN. Further, at step 636, SG-V 302 sends an acknowledgement ANM message to VMSC/VLR-V 110.

In one embodiment of the present invention, prepaid SCP-H 114 can play a recording on subscriber 106's MDN while the call is in progress. Hence, at step 638, prepaid SCP-H 114 sends a Call Control Directive (CCDIR) operation with an AoC, balance, and announcement list to SG-H 304, which at step 640 is relayed to SG-V 302. It will be apparent to a person skilled in the art that this action is performed while the call between subscriber 106 and subscriber ‘B’ is in progress. CCDIR operation is used during call processing to control VMSC (which is VMSC-V 110) operation for the indicated call. In case SG-V 302 has a service node that supports ISUP voice trunking interface with VMSC/VLR-V 110, SG-V 302 can directly play the AoC, balance and announcement list, at step 642. In an exemplary case, subscriber 106 may listen to a recording that says, “Your prepaid account balance is low. Kindly recharge your prepaid account to continue uninterrupted services”. However, in an alternate embodiment, when SG-V 302 does not have any service node, it can simply send an acknowledgement ‘ccdir’ message to SG-H 304, without playing any announcement. Thus, at step 644, SG-V 302 sends ‘ccdir’ message to SG-H 304, which at step 646 is relayed to prepaid SCP-H 114. Further, at step 648, prepaid SCP-H 114 sends a RESETTIMER operation to SG-H 304, which at step 650 is relayed to SG-V 302. Thereafter, at step 652, SG-V 302 returns an acknowledgement ‘resettimer’ message to SG-H 304, which is further relayed at step 654 to prepaid SCP-H 114. RESETTIMER operation is used to initialize and start an operation timer, and avoid the timeout that would otherwise occur and cause false billing. Steps 638 to 654 are optional, and hence represented in dashed line in FIGS. 6A, 6B, 6C, and 6D.

In another embodiment of the present invention, prepaid account of subscriber 106 may not be sufficient to continue the ongoing call. Hence, in such a case, at step 656, prepaid SCP-H 114 stops the billing and subsequently issues a CCDIR operation to SG-H 304, which is relayed at step 658 to SG-V 302 in order to request disconnection of the ongoing call. In one embodiment of the present invention, SG-V 302 makes an announcement for disconnecting the ongoing call, in case SG-V 302 supports voice trunking with VMSC/VLR-V 110. In an exemplary scenario, SG-V 302 intimates subscriber 106 for disconnecting the ongoing call, by playing a recording that says, “Balance in your prepaid account is not sufficient to continue the ongoing call. Please recharge your account to avoid any further inconvenience”. Thereafter, at step 660, SG-V 302 releases the call on the MDN by sending a release message such as REL to VMSC/VLR-V 110. Further, at step 662, VMSC/VLR-V 110 returns an acknowledgement Release Complete (RLC) message to SG-V 302, in order to release the voice trunk used for the call setup. Thereafter, at step 664, SG-V 302 sends an acknowledgement ‘ccdir’ message to SG-H 304, which at step 666 is relayed to prepaid SCP-H 114.

In yet another embodiment of the present invention, subscriber 106 may disconnect the ongoing call. Thus, at step 668, VMSC/VLR-V 110 sends an REL message to SG-V 302, which at step 670 issues an ODISCONNECT operation on the MIN and MDN to SG-H 304, with CgPA as VMSC/VLR-V 110 address and CdPA as prepaid SCP-H 114. SG-H 304 then modifies the received ODISCONNECT operation, by adding WINCAP parameter and modifying TRANSCAP parameter, and subsequently sends this modified ODISCONNECT operation to prepaid SCP-H 114, at step 672. Thereafter, at step 674, prepaid SCP-H 114 stops the billing on subscriber 106's MDN, and responds with an acknowledgement ‘odisconnect’ message to SG-H 304, which relays it to SG-V 302 at step 676. Subsequently, at step 678, SG-V 302 issues an acknowledgement REL message to VMSC/VLR-V 110, in order to terminate the ongoing call processing. This causes VMSC/VLR-V 110, at step 680, to issue an RLC message to SG-V 302, in order to release the voice trunk used for the call setup. Finally, at step 682, SG-V 302 returns an acknowledgement RLC message to VMSC/VLR-V 110.

It will be apparent to a person skilled in the art that similar to the second CDMA roaming solution (i.e. ‘prepaid roaming without a leased line’) even in case of the first CDMA roaming solution (i.e. ‘prepaid roaming using a leased line’), the call flow of MO call remains unchanged. However, in this solution, since there is only SG (i.e. SG 102), which has a combined functionality of SG-V 302 and SG-H 304, SG 102 acts as the sole interface to exchange signaling between VMSC/VLR-V 110 and prepaid SCP-H 114. Any signaling message, which was earlier exchanged between SG-V 302 and VMSC/VLR-V, will now be exchanged between SG 102 and VMSC/VLR-V 110. Likewise, any signaling message, which was earlier exchanged between SG-H 304 and prepaid SCP-H 114, will now be exchanged between SG 102 and prepaid SCP-H 114. Moreover, it will also be apparent to a person of skill in the art that the need for encapsulated signaling exchange between SG-V 302 and SG-H 304 is eliminated as SG 102 itself handles those messages with appropriate intended recipients.

As mentioned earlier, subscriber 106 can also receive calls while he is roaming in partner VPMN 104. FIGS. 7A, 7B, and 7C represent a flow diagram of MT call received on prepaid subscriber 106's handset while roaming in partner VPMN 104, in accordance with an embodiment of the present invention. At step 702, when a calling party ‘B’ calls subscriber 106's MDN, call request IAM (B, MDN) is received at GMSC-H 126. Upon receiving the terminating call request for subscriber 106, GMSC-H 126 sends a Location Request (LOCREQ) message on the MDN to HLR-H 112, with WINCAP and TRANSCAP parameters to request for WIN phase 2 trigger profile information, at step 704. Thus, at step 706, HLR-H 112 returns the trigger profile information (i.e. TRIGADDRLIST) and subscriber 106's location (i.e. GT of HPMN 108) in an acknowledgement ‘locreq’ message to GMSC-H 126. HLR-H 112 returns subscriber 106's location due to fake registration process (i.e. performed earlier) of subscriber 106 in VPMN 104. Thereafter, at step 708, GMSC-H 126 sends an ANLYZD message to prepaid SCP-H 114, with the calling party ‘B’ number, MDN, MIN, and address of SG-H 304. Prepaid SCP-H 114 then returns instructions to GMSC-H 126 to continue the call processing in an acknowledgement ‘anlyzd’ message, at step 710.

In an embodiment of the present invention, in case GMSC-H 126 has not received subscriber 106's location information (i.e. SG-H 304 address) in the ‘locreq’ message, then at step 712, GMSC-H 126 sends a second LOCREQ message on the MDN to HLR-H 112, with the WINCAP and TRANSCAP parameters requesting routing information from HLR-H 112. Therefore, at step 714, HLR-H 112 sends a routing request message, such as ROUTREQ on subscriber 106's MIN to SG-H 304, which at step 716 is relayed to VMSC/VLR-V 110. Further, at step 718, VMSC/VLR-V 110 assigns a Temporary Local Directory Number (TLDN) for the called MDN and returns the assigned TLDN in an acknowledgement ‘routreq’ message to SG-H 304, which at step 720 is relayed to HLR-H 112. Thereafter, at step 722, HLR-H 112 returns the TLDN and the routing information to GMSC-H 126 in an acknowledgement ‘locreq’ message.

Since GMSC-H 126 has the TLDN and routing information, it uses this information to modify the call request as IAM (B, TLDN) and sends it to VMSC/VLR-V 110, at step 724. Thereafter, at step 726, VMSC/VLR-V 110 issues ACM and subsequently ANM to GMSC-H 126, in order to indicate that voice trunks for the ongoing call are reserved and subscriber 106 has answered the call, respectively. At step 728, GMSC-H 126 sends a TANSWER message on the MDN to prepaid SCP-H 114, with the WINCAP and TRANSCAP parameters. Prepaid SCP-H 114 then starts the billing on subscriber 106's MDN. In an embodiment of the present invention, prepaid SCP-H 114 is defined with a tariff plan for subscriber 106 based on his current location, in case the tariff for that location is not defined until that point. This is required as prepaid SCP-H 114 does not know the tariff plan specific to the location of subscriber 106, and hence is unable to correctly bill subscriber 106's MDN. As described earlier, SG-H 304 can be assigned a separate GT of HPMN 108 for each of the partner VPMNs. In such a case, for each partner VPMN, SG-H 304 will be assigned corresponding HPMN 108 GT, and corresponding tariff will be defined at prepaid SCP-H 114. Further, at step 730, prepaid SCP-H 114 returns an acknowledgement ‘tanswer’ message to GMSC-H 126 to indicate the continuation of call processing.

In an embodiment of the present invention, subscriber 106 may disconnect the ongoing call. Hence, in such a case, VMSC/VLR-V 110 at step 732 sends a release message, such as REL to GMSC-H 126 indicating termination of the call by subscriber 106. Thereafter, at step 734, GMSC-H 126 sends a TDISCONNECT message on the MDN to prepaid SCP-H 114, with the WINCAP and TRANSCAP parameters. This results in prepaid SCP-H 114 to stop the billing on subscriber 106's MDN. In addition, at step 736, prepaid SCP-H 114 responds with an acknowledgement ‘tdisconnect’ message to GMSC-H 126. This causes GMSC-H 126, at step 738, to release the trunk by sending an RLC message to VMSC/VLR-V 110.

In an alternate embodiment of the present invention, in case the balance in the prepaid account of subscriber 106 is not sufficient to pursue the ongoing call, prepaid SCP-H 114 stops the billing and issues a CCDIR operation to GMSC-H 126 at step 740, in order to request for disconnection of the ongoing call. Thus, at step 742, GMSC-H 126 sends an acknowledgement ‘ccdir’ message to prepaid SCP-H 114. Thereafter, at step 744, GMSC-H 126 releases the call on subscriber 106's MDN by sending a release message such as REL to VMSC/VLR-V 110. This finally causes VMSC/VLR-V 110, at step 746, to send an acknowledgement RLC message to GMSC-H 126, in order to release the voice trunk. It will be apparent to a person skilled in the art that various steps in MT call flow in case of the first CDMA roaming solution follows that of the second CDMA roaming solution except that SG 102, instead of SG-H 304 interacts with various network elements described in FIGS. 7A, 7B, and 7C.

In an embodiment of the present invention, subscriber 106 may also wish to initiate SMS, while he is roaming in VPMN 104. The message flow for MO SMS in case of ‘prepaid roaming without a leased line’ solution’ follows a standard MO SMS message flow, where a subscriber sends an SMS to a destination number, which reaches his HPMN MC (i.e. Message Center coupled to HPMN 108) without involving either SG-V 302 or SG-H 304. It will be apparent to a person skilled in the art that in case CdPA is HPMN MC, then the routing is done on E.164 address of HPMN MC. As there is no configuration done at any of the components in VPMN 104 for redirecting E.164 address, normal flow of the SMS will take place. In another embodiment of the present invention, in case the subscriber's SMS is destined to HPMN MIN, and since the operator in VPMN 104 has done a configuration to route E.212 address of the MIN (i.e. HPMN MIN) to SG-V 302, the subscriber's SMS will be first received at SG-V 302. However, SG-V 302 will not perform any modification (or apply any logic), but will simply route the received SMS to the HPMN MC. The rest of the SMS delivery flow will be similar to standard SMS message flow. It will be apparent to person skilled in the art that even in the first CDMA roaming solution everything will remain identical to the second CDMA roaming solution, except that SG 102, instead of SG-V 302 and SG-H 304, will be involved in this case.

In another embodiment of the present invention, subscriber 106 may receive an MT-SMS while roaming in VPMN 104. In case of ‘prepaid roaming without a leased line’ solution, when an SMS for the subscriber's MDN is received at an originating MC, the originating MC will send a routing information request, such as SMS Request (SMSREQ) on the subscriber's MDN, to HLR-H 112. SMSREQ is sent to HLR-H 112 to determine the location of subscriber 106, and to check whether subscriber 106 is allowed to receive SMS. HLR-H 112 will then return SG-H 304 address and MIN corresponding to subscriber 106's MDN, to the originating MC. Thereafter, the originating MC can forward the SMS by sending an SMS Delivery Point to Point (SMDPP) message to SG-H 304, which can further relay to VMSC/VLR-V 110 (that is eventually delivered to subscriber 106's handset). In an embodiment of the present invention, when subscriber 106 is unable to receive the SMS, the originating MC will retain the SMS, and will resend when VMSC/VLR-V 110 later indicates the availability of subscriber 106. The call flow for MO SMS in case of the first CDMA roaming solution follows the second CDMA roaming solution, except that SG 102, instead of SG-H 304, will be involved in this case.

The prepaid solution explained above has described a CDMA solution to allow subscribers of WIN phase 2 capable HPMN to roam in partner VPMN, and thereby avail WIN phase 2 services while roaming in this partner VPMN, even when the HPMN restricts roaming with WIN phase 2 support. It will be apparent to a person skilled in the art that similar prepaid roaming solution can also be provided to subscribers using the GSM standard. However, in this case, the HPMN would have CAMEL or IN support, while the partner VPMN would not be having roaming support for CAMEL or IN. Furthermore, the HPMN (i.e. HPMN 108) would restrict CAMEL or IN roaming in the partner VPMN in this case. The solution will involve the partner VPMN implementing ISUP voice trunk loopback to SG-V 302 (or SG 102 in case of ‘prepaid roaming using a leased line’ solution) for special prefixed calling numbers (i.e. the prefix is added by SG-V 302 or SG 102 to these calling numbers). In an embodiment of the present invention, in case the partner VPMN supports Intelligent Network Application Part (INAP) protocol, SG-V 302 (or SG 102) will interact with VMSC/VLR-V 110 via INAP protocol, instead of ISUP. However, this requires IN triggers that can be defined on calling number prefixes. SG-V 302 (or SG 102), in case of GSM, will interact with prepaid SCP-H 114 via Camel Application Part (CAP) protocol, and will emulate prepaid SCP-H 114 (and HLR-H 112) that subscriber 106 is in his HPMN. In addition, even in GSM solution, as in CDMA solution, STP-V 116 will be configured to redirect signaling messages with CdPA as HPMN, to SG-V 302 (or SG 102). Further, SG-H 304 (or SG 102) will imitate partner VPMN's CAMEL support in addition to subscriber 106's location, at HLR-H 112, in order to receive subscriber 106's roaming profile information from HLR-H 112.

It will also be apparent to a person skilled in the art that the prepaid roaming solution can be provided to subscribers using other technologies such as, but not limited to, VoIP, WiFi, 2G, 3G, and inter-standard roaming. For example, a 3G roaming subscriber traveling to a VPMN may like to avail wireless services similar to the ones he receives in his HPMN. To support these variations, SG-V 302 (or SG 102) will have a separate SS7 and network interface corresponding to the VPMN network. Similarly, SG-H 304 (or SG 102) will have a separate SS7 and network interface corresponding to the HPMN network. It would be obvious to a person skilled in the art that these two interfaces in different directions may not have to be the same technologies. In addition, there could be multiple types of interfaces in both directions.

An exemplary list of the mapping between GSM MAP/CAP and ANSI41D is described in the table below as a reference.

| GSM MAP/CAP | ANSI 41D |
|---|---|
| Location Update/ISD | REGNOT |
| Cancel Location | REGCAN |
| RegisterSS | FEATUREREQUEST |
| InterrogateSS | FEATUREREQUEST |
| SRI-SM | SMSREQ |
| SRI | LOCREQ |
| ForwardSMS | SMSDPP |
| ReadyForSMS | SMSNOTIFICATION |
| AlertServiceCenter | SMSNOTIFICATION |
| ReportSMSDelivery | SMDPP |
| ProvideRoamingNumber | ROUTREQ |
| Initial DP | ORREQ |
| Initial DP | ANLYZD |
| Initial DP | OANSWER |
| Connect/ReleaseCall/Continue/Cancel | CCDIR |
| Reset Timer | RESETTIMER |
| Initial DP | ODISCONNECT |
| Initial DP | TANSWER |
| Initial DP | TDISCONNECT |

An HPMN operator, or partner VPMN operator or an MVNO operator of the HPMN operator uses one or more variations of the present invention to allow prepaid subscribers of WIN phase 2 (or CAMEL) HPMN to outbound roam with WIN phase 2 (or CAMEL) capabilities in the partner VPMN, even when the HPMN restricts roaming with WIN phase 2 support in the partner VPMN. Moreover, this is irrespective of whether the partner VPMN has WIN phase 2 (or CAMEL) capabilities. The present invention helps the HPMN prepaid subscribers to avail standard services (like initiate calls and SMS, and receive calls and SMS) in addition to WIN phase 2 specific services, while roaming in the partner VPMN. This result in attracting more of outbound roaming HPMN prepaid subscribers to register at the partner VPMN. In addition, cutting down the cost of upgrading existing components and installing new components to the existing network eventually leads to maximizing roaming revenues for network operator deploying this solution. Further, the present invention provides two different implementations (based on requirement of number of components to be installed) of this solution catering to specific infrastructural limitations of the network operators.

The present invention can take the form of an entirely hardware embodiment, an entirely software embodiment, or an embodiment containing both hardware and software elements. In accordance with an embodiment of the present invention, software, including but not limited to, firmware, resident software, and microcode, implements the invention.

Furthermore, the invention can take the form of a computer program product, accessible from a computer-usable or computer-readable medium providing program code for use by, or in connection with, a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CDROM), compact disk-read/write (CD-R/W) and Digital Versatile Disk (DVD).

A computer usable medium provided herein includes a computer usable program code, which when executed, provides wireless services to a prepaid subscriber of an HPMN in a VPMN. The computer program product further includes a computer usable program code for detecting at a first Signal Gateway (SG) of one or more SGs, a registration attempt by the prepaid subscriber at the VPMN. The computer program product further includes a computer usable program code for causing an HLR associated with the HPMN to send a trigger profile information in a registration acknowledgement message to the first SG in response to a modified registration message, sent by the first SG, so as to imitate the VPMN's roaming support for WIN phase 2 and the prepaid subscriber's registration attempt at the HPMN that has a WIN phase 2 support. The computer program product further includes a computer usable program code for sending by the first SG, a modified registration acknowledgement message to a VMSC/VLR associated with the VPMN to facilitate the prepaid subscriber's mobile communication in the VPMN.

The components of present system described above include any combination of computing components and devices operating together. The components of the present system can also be components or subsystems within a larger computer system or network. The present system components can also be coupled with any number of other components (not shown), such as other buses, controllers, memory devices, and data input/output devices, in any number of combinations. In addition, any number or combination of other processor-based components may be carrying out the functions of the present system.

It should be noted that the various components disclosed herein may be described using computer aided design tools and/or expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but may not be limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, it covers all of the following interpretations: any of the items in the list, all of the items in the list and any combination of the items in the list.

The above description of illustrated embodiments of the present system is not intended to be exhaustive or to limit the present system to the precise form disclosed. While specific embodiments of, and examples for, the present system are described herein for illustrative purposes, various equivalent modifications are possible within the scope of the present system, as those skilled in the art will recognize. The teachings of the present system provided herein can be applied to other processing systems and methods. They may not be limited to the systems and methods described above.

The elements and acts of the various embodiments described above can be combined to provide further embodiments. These and other changes can be made in light of the above detailed description.

Other Variations

Provided above for the edification of those of ordinary skill in the art, and not as a limitation on the scope of the invention, are detailed illustrations of a scheme for providing wireless services to a prepaid subscriber of an HPMN roaming in a VPMN. Numerous variations and modifications within the spirit of the present invention will of course occur to those of ordinary skill in the art in view of the embodiments that have been disclosed. For example, the present invention is implemented primarily from the point of view of GSM mobile networks as described in the embodiments. However, the present invention may also be effectively implemented on GPRS, 3G, CDMA, WCDMA, WiMax etc., or any other network of common carrier telecommunications in which end users are normally configured to operate within a “home” network to which they normally subscribe, but have the capability of also operating on other neighboring networks, which may even be across international borders.

The examples under the system of present invention detailed in the illustrative examples contained herein are described using terms and constructs drawn largely from GSM mobile telephony infrastructure. However, use of these examples should not be interpreted as limiting the invention to those media. The system and method can be of use and provided through any type of telecommunications medium, including without limitation: (i) any mobile telephony network including without limitation GSM, 3GSM, 3G, CDMA, WCDMA or GPRS, satellite phones or other mobile telephone networks or systems; (ii) any so-called WiFi apparatus normally used in a home or subscribed network, but also configured for use on a visited or non-home or non-accustomed network, including apparatus not dedicated to telecommunications such as personal computers, Palm-type or Windows Mobile devices; (iii) an entertainment console platform such as Sony Playstation, PSP or other apparatus that are capable of sending and receiving telecommunications over home or non-home networks, or even (iv) fixed-line devices made for receiving communications, but capable of deployment in numerous locations while preserving a persistent subscriber id such as the eye2eye devices from Dlink; or telecommunications equipment meant for voice over IP communications such as those provided by Vonage or Packet8.

In describing certain embodiments of the system under the present invention, this specification follows the path of a telecommunications call, from a calling party to a called party. For the avoidance of doubt, such a call can be a normal voice call, in which the subscriber telecommunications equipment is also capable of visual, audiovisual or motion-picture display. Alternatively, those devices or calls can be for text, video, pictures or other communicated data.

In the foregoing specification, specific embodiments of the present invention have been described. However, one of ordinary skill in the art will appreciate that various modifications and changes can be made without departing from the scope of the present invention as set forth in the claims below. Accordingly, the specification and the figures are to be regarded in an illustrative rather than a restrictive sense, and all such modifications are intended to be included within the scope of present invention. The benefits, advantages, solutions to problems, and any element(s) that may cause any benefit, advantage, or solution to occur, or to become more pronounced, are not to be construed as a critical, required, or essential feature or element of any or all of the claims.

APPENDIX

| Acronym | Description |
|---|---|
| 3G | Third Generation of mobile |
| 3GPP | Third Generation Partnership Project |
| ACM | ISUP Address Completion Message |
| ANLYZD | Analyzed Information |
| ANM | ISUP Answer Message |
| ANSI-41 | American National Standards Institute #41 |
| AUTHDIR | Authentication Directive |
| AUTHREQ | Authentication Request |
| CAMEL | Customized Applications for Mobile network |
| | Enhanced Logic |
| CAP | Camel Application Part |
| CCDIR | Call Control Directive |
| CDMA | Code Division Multiplexed Access |
| CdPA | Called Party Address |
| CgPA | Calling Party Address |
| CONNRES | Connect Resource |
| DISCONNRES | Disconnect Resource |
| DP | Detection Point |
| DPC | Destination Point Code |
| DSD | Delete Subscriber Data |
| ESN | Electronic Serial Number |
| GMSC | Gateway MSC |
| GPRS | General Packet Radio System |
| GSM | Global System for Mobile |
| GT | Global Title |
| HLR | Home Location Register |
| HLR-H | HPMN HLR |
| HPMN | Home Public Mobile Network |
| IAM | Initial Address Message |
| IN | Intelligent Network |
| IP | Intelligent Peripheral |
| IS-41 | Interim Standard-41 |
| ISD | MAP Insert Subscriber Data |
| ISTP | International STP |
| ISUP | ISDN User Part |
| LOCREQ | Location Request |
| LUP | MAP Location Update |
| MAP | Mobile Application Part |
| MC | Message Center |
| MDN | Mobile Directory Number |
| MIN | Mobile Identification Number |
| MO | Mobile Originated |
| MSC | Mobile Switching Center |
| MT | Mobile Terminated |
| MTP | Message Transfer Part |
| MVNO | Mobile Virtual Network Operator |
| NP | Numbering Plan |
| OANSWER | Origination Answer |
| ODISCONNECT | Origination Disconnect |
| ORREQ | Origination Request |
| NPI | Numbering Plan Indicator |
| QUALDIR | Qualification Directive |
| QUALREQ | Qualification Request |
| REGCAN | Registration Cancellation |
| REGNOT | MAP Registration Notification |
| ROUTREQ | Routing Request |
| PRN | MAP Provide Roaming Number |
| REL | ISUP Release Message |
| RI | Routing Indicator |
| SCCP | Signaling Connection Control part |
| SCP | Signaling Control Point |
| SG | Signal Gateway |
| SMS | Short Message Service |
| SMDPP | SMS Delivery Point to Point |
| SMSREQ | SMS Request |
| SN | Service Node |
| SPC | Signaling Point Code |
| SRI | MAP Send Routing Information |
| SRI-SM | MAP Send Routing Information For Short Message |
| SS7 | Signaling System #7 |
| SSP | Service Switch Point |
| STP | Signaling Transfer Point |
| TANSWER | Termination Answer |
| TCAP | Transaction Capabilities Application Part |
| TDISCONNECT | Termination Disconnect |
| TLDN | Temporary Local Directory Number |
| TRANSCAP | Transaction Capability |
| TT | Translation Type |
| USSD | Unstructured Supplementary Service Data |
| VAS | Value Added Service |
| VLR | Visited Location Register |
| VLR-V | VPMN VLR |
| VMSC | Visited Mobile Switching Center |
| VMSC-V | VPMN VMSC |
| VPMN | Visited Public Mobile Network |
| WIN | Wireless Intelligent Network |
| WINCAP | WIN Capability |

Technical References (Each of which is Incorporated by this Reference Herein):
GSM 902 on MAP specification
Digital cellular telecommunications system (Phase 2+)
Mobile Application Part (MAP) Specification
(3GPP TS 09.02 version 7.9.0 Release 1998)
GSM 340 on SMS
Digital cellular telecommunications system (Phase 2+)
Technical realization of the Short Message Service (SMS)
(GSM 03.40 version 7.4.0 Release 1998)
GSM 378 on CAMEL,
GSM 978 on CAMEL Application Protocol,
GSM 379 on CAMEL Support of Optimal Routing (SOR),
GSM 318 on CAMEL Basic Call Handling
ITU-T Recommendation Q.1214 (1995), Distributed functional plane for intelligent network CS-1,
ITU-T Recommendation Q.1218 (1995), Interface Recommendation for intelligent network CS-1,
ITU-T Recommendation Q.762 (1999), Signaling system No. 7—ISDN user part general functions of messages and signals,
ITU-T Recommendation Q.763 (1999), Signaling system No. 7—ISDN user part formats and codes,
ITU-T Recommendation Q.764 (1999), Signaling system No. 7—ISDN user part signaling procedures,
ITU-T Recommendation Q.766 (1993), Performance objectives in the integrated services digital network application,
ITU-T Recommendation Q.765 (1998), Signaling system No. 7—Application transport mechanism,
ITU-T Recommendation Q.769.1 (1999), Signaling system No. 7—ISDN user part enhancements for the support of Number Portability
IS-41 D MAP,
IS-771 WIN Phase 1,
IS-826 WIN Phase 2 Prepaid Charging,
IS-848 WIN Phase 2 additional applications,
IS-843 WIN Phase 3 location-based applications

I claim:

1. A system for providing wireless services to a prepaid subscriber of a Home Public Mobile Network (HPMN) in a Visited Public Mobile Network (VPMN), the HPMN having a Mobile Virtual Network Operator (MVNO), Wireless Intelligent Network (WIN) phase 2 capability, and an associated Home Location Register (HLR), the VPMN having an associated Visited Mobile Switching Center/Visited Location Register (VMSC/VLR), the system comprising:
a first Signal Gateway (SG) for detecting a registration attempt by the prepaid subscriber at the VPMN;
circuitry for sending a modified registration message to imitate the VPMN's roaming support for WIN phase 2 capability;
circuitry for causing the HLR to send a registration acknowledgement message with trigger profile information to the first SG in response to the first modified registration message; and
circuitry for sending a modified registration acknowledgement message to the VMSC/VLR to facilitate the prepaid subscriber's mobile communication in the VPMN;
wherein the first SG is coupled to one selected from a group consisting of the VPMN, the HPMN, and the MVNO.

2. The system of claim 1, wherein the HPMN has an associated gateway switching center;
wherein the first SG is coupled to the VPMN; and
wherein the first SG communicates with the gateway switching center via a leased line connection.

3. The system of claim 2, wherein the HPMN uses a Global Title (GT) and a Signaling Point Code (SPC); and
wherein the first SG indicates its presence in the HPMN by communicating with the HPMN using the HPMN GT and the HPMN SPC.

4. The system of claim 2, wherein the VPMN uses a GT and a SPC; and
wherein the first SG indicates its presence in the VPMN by communicating with the VPMN using the VPMN GT and the VPMN SPC.

5. The system of claim 1, wherein the VPMN has an associated gateway switching center;
wherein the first SG is coupled to one selected from a group consisting of the HPMN and the MVNO; and
wherein the HPMN communicates with the gateway switching center associated with the VPMN via a leased line connection.

6. The system of claim 1 further comprising:
a second SG coupled to one selected from a group consisting of the HPMN and the MVNO;
wherein the first SG is coupled to the VPMN.

7. The system of claim 6, wherein the modified registration message is sent by the second SG; and
wherein the second SG causes the HLR to send the trigger profile information to the second SG in response to the modified registration message.

8. The system of claim 6, wherein the second SG communicates with the first SG via one selected from a group consisting of a Signaling System 7 (SS7) encapsulated link and an Internet Protocol (IP) encapsulated link.

9. The system of claim 1, wherein the prepaid subscriber has a Mobile Directory Number (MDN);
wherein the trigger profile information is stored at the first SG; and
wherein the first SG modifies the registration acknowledgement message based on the trigger profile by adding a configurable prefix to the MDN to facilitate the prepaid subscriber's mobile communication.

10. The system of claim 1, wherein the HPMN has a GT, the system further comprising:
a second SG coupled to the HPMN;
wherein one of the first SG or the second SG updates the HLR by modifying an address of the VMSC/VLR in the registration message with the GT.

11. The system of claim 1, further comprising:
a second SG coupled to the HPMN;
wherein the VMSC/VLR sends a TRANSCAP parameter, which is received by one selected from a group consisting of the first SG and the second SG; and
wherein the TRANSCAP parameter is replaced with a modified TRANSCAP parameter indicating the VPMN's support for the trigger profile information to the HLR.

12. The system of claim 1, further comprising:
a second SG coupled to the HPMN;
wherein one of the first SG or the second SG modifies the registration message by adding a WIN Capability (WINCAP) parameter to indicate the VPMN's prepaid roaming support for WIN phase 2 at the HLR.

13. The system of claim 1, wherein the VPMN has an associated roaming Signaling Transfer Point (STP) configured to redirect all signaling messages corresponding to the prepaid subscriber, destined for the HPMN, to the first SG.

14. The system of claim 1, wherein the VMSC/VLR is configured to establish a connection from one selected from a group consisting of an ISDN User Part (ISUP) voice trunk loopback and an ISUP signaling, to the first SG to route all signaling messages corresponding to the prepaid subscriber.

15. The system of claim 1, wherein the HPMN has an associated prepaid Signaling Control Point (SCP), and wherein the SCP is configured to define a tariff for the prepaid subscriber based on the prepaid subscriber's current location.

16. A method of providing wireless services to a prepaid subscriber of an HPMN in a VPMN, the HPMN having a Mobile Virtual Network Operator (MVNO), Wireless Intelligent Network (WIN) phase 2 capability, and an associated Home Location Register (HLR), the VPMN having an associated Visited Mobile Switching Center/Visited Location Register (VMSC/VLR), the method comprising:
detecting a registration attempt by the prepaid subscriber at the VPMN via a first SG;
sending a first modified registration message to imitate the VPMN's roaming support for WIN phase 2 capability;
sending, via the HLR, a registration acknowledgement message with trigger profile information to the first SG in response to the first modified registration message; and
sending a second modified registration acknowledgement message to the VMSC/VLR to facilitate the prepaid subscriber's mobile communication in the VPMN;
wherein the first SG is coupled to one selected from a group consisting of the VPMN, the HPMN, and the MVNO.

17. The method of claim 16, wherein a second SG is coupled to one selected from a group consisting of the HPMN and the MVNO;
wherein the first SG is coupled to the VPMN;
wherein the modified registration message is sent by the second SG; and
wherein the second SG causes the HLR to send the trigger profile information to the second SG in response to the modified registration message.

18. The method of claim 16, wherein the prepaid subscriber has a Mobile Directory Number (MDN);
wherein the trigger profile information is stored at the first SG; and
wherein first SG modifies the registration acknowledgement message based on the trigger profile by adding a configurable prefix to the MDN to facilitate the prepaid subscriber's mobile communication.

19. The method of claim 16, wherein the prepaid subscriber has a Mobile Identification Number (MIN) and a MDN, wherein the HLR has a HLR address, wherein the VMSC/VLR has a VMSC/VLR address, and wherein a second SG is coupled to the HPMN, the method further comprising:
storing, at one of the first SG or the second SG, at least one selected from a group consisting of the trigger profile information, the MIN, the MDN the HLR address, and the VMSC/VLR address.

20. The method of claim 16, wherein the HPMN has a GT and the VMSC/VLR has a VMSC/VLR address;
wherein a second SG is coupled to the HPMN; and
wherein one of the first SG and the second SG updates the HLR by modifying the VMSC/VLR address in the registration message with the HPMN GT.

21. The method of claim 16, wherein a second SG is coupled to the HPMN;
wherein the VMSC/VLR sends a TRANSCAP parameter, which is received by one selected from a group consisting of the first SG and the second SG; and
wherein the TRANSCAP parameter is replaced with a modified TRANSCAP parameter indicating the VPMN's support for the trigger profile information.

22. The method of claim 16, wherein a second SG coupled to the HPMN; and
wherein one of the first SG or the second SG modifies the registration message by adding a WIN Capability (WINCAP) parameter to indicate the VPMN's prepaid roaming support for WIN phase 2 at the HLR.

23. The method of claim 16, wherein the VPMN has an associated roaming Signaling Transfer Point (STP) configured to redirect all signaling messages corresponding to the prepaid subscriber, destined for the HPMN, to the first SG.

24. The method of claim 16, wherein the VMSC/VLR is configured to establish a connection from one selected from a group consisting of an ISDN User Part (ISUP) voice trunk loopback and an ISUP signaling, to the first SG to route all signaling messages corresponding to the prepaid subscriber.

25. The method of claim 16, wherein the HPMN has an associated prepaid Signaling Control Point (SCP), the method further comprising:
configuring the SCP to define a tariff for the prepaid subscriber based on the prepaid subscriber's current location.

26. A computer program product comprising a computer usable medium including a computer usable program code stored thereon for providing wireless services to a prepaid subscriber of an HPMN in a VPMN, the HPMN having a Mobile Virtual Network Operator (MVNO), Wireless Intelligent Network (WIN) phase 2 capability, and an associated Home Location Register (HLR), the VPMN having an associated Visited Mobile Switching Center/Visited Location Register (VMSC/VLR), the computer program product comprising:
first computer useable program code means for detecting a registration attempt by the prepaid subscriber at the VPMN via a first SG;
second computer useable program code means for sending a first modified registration message to imitate the VPMN's roaming support for WIN phase 2 capability;
third computer useable program code means for sending, via the HLR, a registration acknowledgement message with trigger profile information to the first SG in response to the first modified registration message; and
fourth computer useable program code means for sending a second modified registration acknowledgement message to the VMSC/VLR to facilitate the prepaid subscriber's mobile communication in the VPMN;
wherein the first SG is coupled to one selected from a group consisting of the VPMN, the HPMN, and the MVNO.
